(19) United States
(12) Patent Application Publication
(10) Pub. No.: US 2026/0105437 A1
(43) Pub. Date: Apr. 16, 2026

(54) SECURE CONTACTLESS PAYMENT AUTHENTICATION VIA A ZERO-DOLLAR TRANSACTION

(71) Applicant: Capital One Services, LLC, McLean, VA (US)

(72) Inventors: Paul Moreton, McLean, VA (US); Thomas Poole, McLean, VA (US)

(73) Assignee: Capital One Services, LLC, McLean, VA (US)

(21) Appl. No.: 18/917,173

(22) Filed: Oct. 16, 2024

(51) Int. Cl. G06Q 20/34; G06Q 20/40

(52) U.S. Cl. CPC G06Q 20/352; G06Q 20/341; G06Q 20/4014

(57) ABSTRACT

Embodiments include techniques to authenticate a user via a traditional payment processing system. For example, a server receives a request involving a contactless card that includes a card number and a request type indicating authentication. The card number is read when the card is within communication range of the device. Computer processors determine that the request type is for user authentication. The server retrieves an indicator identifying the user by matching the card number in a data source. The user is authenticated based on this indicator to obtain an authentication result.

### BACKGROUND

As user devices such as mobile phones continue to increase in popularity, ensuring that access to data and private information is securely provisioned and maintained on the user devices continues to be a concern. For instance, in order to access a mobile device or an application executing on the mobile device, it is typically necessary to authenticate a user prior to providing access. However, attackers attempt to circumvent security measures by stealing passwords and eavesdropping on users during the registration and authentication processes (e.g., by conducting a man-in-the-middle attack). Thus, an attacker may attempt to intercept data, such as a public key, that can be used to infer the identity of a user, a user device, or a server computer. An attacker may also attempt to intercept authentication data such as a password or response to a challenge. The intercepted data could be used to track the user's device, or it may be used for illicit purposes. And although additional security measures can be warranted to make it harder for attackers to steal and gain access, in some cases, the additional security measures can also be overly restrictive for legitimate users.

### BRIEF SUMMARY

The systems and techniques discussed herein address the problem of requiring significant modification and issuance of new cards for contactless payment systems to perform token based on authentication. Embodiments include using existing contactless payment rails for authentication by performing a test authorization, e.g., by intercepting a zero-dollar authentication with a special indicator, matching the credit card information to an identity, and maintaining security via device binding. This solution enables credit card tapping to a customer's phone for payment, without requiring new cards or applets, while ensuring security and preventing fraud.

### BRIEF DESCRIPTION OF THE DRAWINGS

To easily identify the discussion of any particular element or act, the most significant digit or digits in a reference number refer to the figure number in which that element is first introduced.

FIG. 1 illustrates a system in accordance with embodiments.

FIG. 2A to FIG. 2B illustrate embodiments of tapping to verify a contactless card using a payment protocol, according to one embodiment presented in this disclosure.

FIG. 3A to FIG. 3C illustrate embodiments of tapping to verify a contactless card using a payment protocol, according to one embodiment presented in this disclosure.

FIG. 4 illustrates a routine relating to authentication via contactless card, according to one embodiment presented in this disclosure.

FIG. 5 illustrates another routine relating to authentication via contactless card, according to one embodiment presented in this disclosure.

FIG. 6 illustrates yet another routine relating to authentication via contactless card, according to one embodiment presented in this disclosure.

FIG. 7 is a sequence diagram depicting a routine relating to authentication via contactless card, according to one embodiment presented in this disclosure.

FIG. 8 is sequence diagram depicting another routine relating to authentication via contactless card, according to one embodiment presented in this disclosure.

FIG. 9 is a sequence diagram depicting yet another routine relating to authentication via contactless card, according to one embodiment presented in this disclosure.

FIG. 10 is a sequence diagram depicting still another routine relating to authentication via contactless card, according to one embodiment presented in this disclosure.

FIG. 11 is a flow diagram depicting a routine relating to authentication via contactless card, according to one embodiment presented in this disclosure.

FIG. 12A to FIG. 12B illustrate a contactless card according to one embodiment presented in this disclosure.

FIG. 13 illustrates a data structure according to one embodiment presented in this disclosure.

FIG. 14 illustrates a computer architecture according to one embodiment presented in this disclosure.

FIG. 15 illustrates an embodiment of a system for verifying or authenticating a contactless card using a payment protocol, according to one embodiment presented in this disclosure.

### DETAILED DESCRIPTION

Embodiments discussed herein utilize existing contactless payment infrastructure to perform authentication operations. This involves intercepting a test transaction, such as a zero-dollar authorization transaction with a unique identifier, and matching credit card information provided with the test transaction to a stored identity. Any party in the transaction chain could perform this interception, effectively linking the card number to the cardholder's identity. Specifically, the party performing the authentication may be the card networking system (e.g., Visa, Mastercard, etc.), a card issuing system, a point-of-sale system, a mobile device, etc.

In embodiments, the process involves tapping the contactless card on a mobile device, such as a mobile phone, and initiating a test transaction or zero-dollar authorization with a specific flag set in a message field. This flag alerts a party's system, such as Visa's system, to intervene. In this example, the networking system intervenes, determines information with or in the message, such as the card number and matches the card number to an identity stored on the networking system. The networking system then returns a result, including the identity back to the mobile device and/or inquiring application. The returned identity can be authenticated against an authentic identity. The identity information may be any type of information associated with a user, e.g., card number, name, address, phone number, customer identifier, etc. In some instances, the identity may be a token and may be encrypted with an encryption algorithm utilizing public-private keys, pre-exchanged diversified keys, etc.

One of the advantages of the techniques discussed herein is that it doesn't require any modifications to existing contactless cards, making them immediately compatible. Further, the zero-dollar authorization is crucial in avoiding issues like “bricking” the card, which could render it unusable due to mismatched transaction counters.

In addition, various embodiments of the present disclosure provide one or more benefits in terms of verifying a contactless card, and in various embodiments as a result of the verification, a user associated with the contactless card, including taking advantage of enhanced security offered by authentication technique associated with payment protocols, but for purposes distinct than making or completing a payment. In various embodiments, utilizing the techniques disclosed herein enhances the efficiency of a computer device, e.g. a mobile phone, by providing a method for authenticating or verifying a contactless card, and in various embodiments, by extension therewith, a user across one or more applications, even if a payment is not associated with the application, and/or even if the one or more applications are distinct in their purpose, e.g. a transportation application in relation to an entertainment application.

Moreover, since one or more payment protocols may have enhanced security given the nature of the authentication associated therewith, e.g., EMV standards are maintained with high security as an objective to avoid the theft of funds, and the security benefits transfer to other contexts and applications. Accordingly, in various embodiments, a payment authorization protocol can be used to efficiently and more securely authenticate a contactless card, and by extension and pursuant to various embodiments associated therewith, a user associated therewith and across different applications and purposes, including wireless communications, transactions and/or operations that do not involve making a payment.

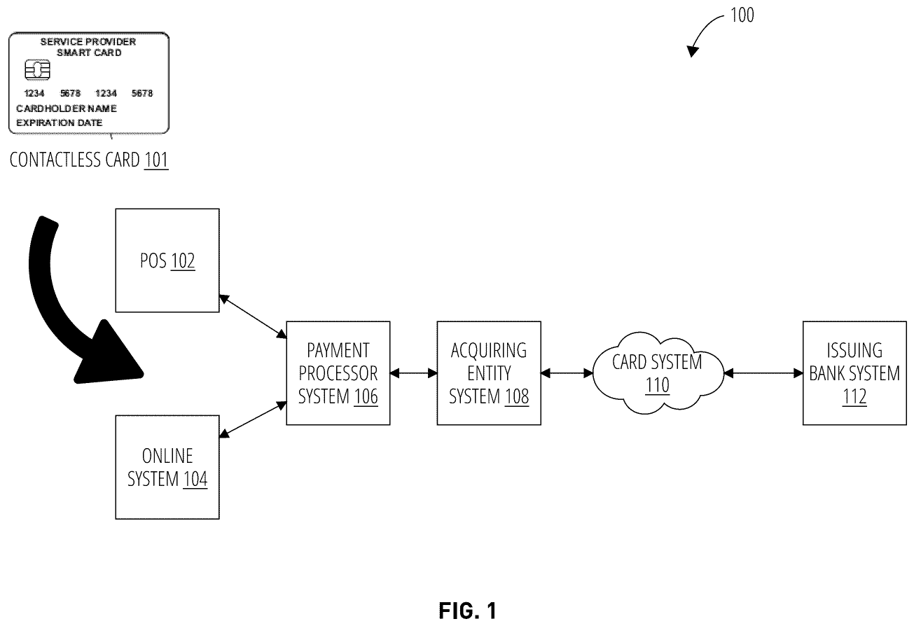

FIG. 1 illustrates an example of a system 100 for processing contactless card payments and authentication operations. As discussed, the system 100 is one configuration for processing payment transactions. However, embodiments discussed enhance and improve the system 100 by enabling it to perform authentication operations to authenticate a user outside of the traditional payment sequence and operations.

The system 100 processes payment and authentication requests that may be received via a point-of-sale system 102 and/or online system 104 via a mobile device (not shown). In some instances, the online system 104 receives the request via a user interacting with the device, such as a mobile device, a personal computer, a laptop computer, etc. The system 100 includes a payment processor system 106, an acquiring entity system 108, a card network system 110, and an issuing bank system 112.

In embodiments, the payment processor system 106 includes services, computing equipment, and technology that facilitates the authorization and processing of credit card and debit card transactions between the acquiring entity system 108 and the issuing bank system 112. The payment processor system 106 includes networking equipment to provide secure transmission of transaction data, fraud detection, and compliance with financial regulations. The payment processor system 106 typically ensures that payments are executed seamlessly, and funds are appropriately transferred from the customer's account to the merchant's account for payment transactions. In one example, the payment processor system 106 is configured to manage the transaction process, including authorization, funding, and settlement.

The acquiring entity system 108 is the acquiring bank's system that processes credit and debit card transactions on behalf of a merchant, performed via the point-of-sale system 102 and/or online system 104. The acquiring entity system 108 includes computing components that facilitate the acceptance of card payments by the merchant and coordinate with the card network system 110 (e.g., Visa, MasterCard) and the issuing bank system 112.

In embodiments, the acquiring entity system 108 includes several components designed to facilitate the acceptance and processing of card transactions for merchants. For example, the acquiring entity system 108 can include a merchant account management component that processes the creation, maintenance, and administration of merchant accounts, enabling businesses to accept card payments. It manages onboarding, account types, and associated fees. The acquiring entity system 108 may also include a transaction processing engine that processes credit and debit card transactions, including authorization, capture, clearing, and settlement. It interacts with the payment gateway, card networks, and issuing banks. In some instances, the acquiring entity system 108 includes a payment gateway integration component that interfaces with payment gateways to transmit transaction data securely from the merchant to the acquiring bank, ensuring data integrity and encryption.

In some instances, the acquiring entity system 108 includes a risk and fraud management component, a clearing and settlement component, and a compliance and security component. The risk and fraud management component processes and employs various techniques, such as machine learning algorithms and rule-based systems, to detect and prevent fraudulent activities in real-time. A clearing and settlement component processes the transfer of funds from issuing banks to the acquiring bank and then to the merchant's account. It ensures accurate calculation and distribution of transaction amounts and fees. The compliance and security component processes algorithms to ensure that the acquiring bank adheres to industry standards and regulations, such as PCI DSS, to protect cardholder data and maintain secure transactions. The compliance and security component also performs encryption, tokenization, and regular security audits.

Further, the system 100 includes a card network system 110, such as Visa® network, MasterCard® network, Discover® network, American Express® network, etc. The card network system 110 includes additional components, such as a core processing network that handles authorization, clearing, and settlement of transactions. It connects merchants, acquirers, issuers, and other stakeholders, ensuring seamless communication and data exchange. In some instances, the card network system 110 includes data centers that house the infrastructure and technology that power card network system 110. They ensure the network's high availability, reliability, and security.

The card network system 110 also includes components that provide a comprehensive suite of services for issuers, acquirers, and processors, including transaction processing, risk management, and fraud prevention. In some instances, the card network system 110 includes a token service that replaces sensitive cardholder data with unique digital tokens, enhancing security and reducing the risk of fraud. The card network system 110 may provide additional components to perform various operations to process transactions, and embodiments are not limited in this manner.

In embodiments, the issuing bank system 112 includes computing infrastructure used by financial institutions to manage the issuance and lifecycle of credit, debit, and prepaid cards. It encompasses card issuance, transaction processing, fraud detection, compliance, and customer support, ensuring secure and efficient card services for customers. When a customer initiates a transaction, the issuing bank system 112 processes the request through functions and processes. As described above, the merchant's POS or website captures the card details and sends a transaction request to their acquiring entity system 108. This request is then routed through the card network system 110 to the issuing bank system 112. For the transactions, the issuing bank system 112 verifies the card information based on stored information, checks for available funds, and assesses potential fraud risks using one or more detection algorithms before deciding to approve or decline the transaction. Upon approval, the issuing bank system 112 sends an approval response, and the merchant receives the approval, and the transaction is completed. Subsequently, the acquiring entity system 108 initiates settlement, electronically transferring funds from the issuing bank system 112 to the merchant's account on the acquiring entity system 108. Finally, the issuing bank system 112 electronically updates the cardholder's account.

As discussed, embodiments discussed herein modify and improve system 100 by enabling any one of the entities to perform authentication operations to authenticate a user without performing a financial transaction, test transactions, or zero-amount authorization. The system 100 processes data from a contactless card 101 to identify a user/owner of the contactless card 101. Thus, the existing contactless payment rails are used to authenticate by intercepting the test transaction or zero-dollar authorization with a special indicator to match the contactless card information to an identity.

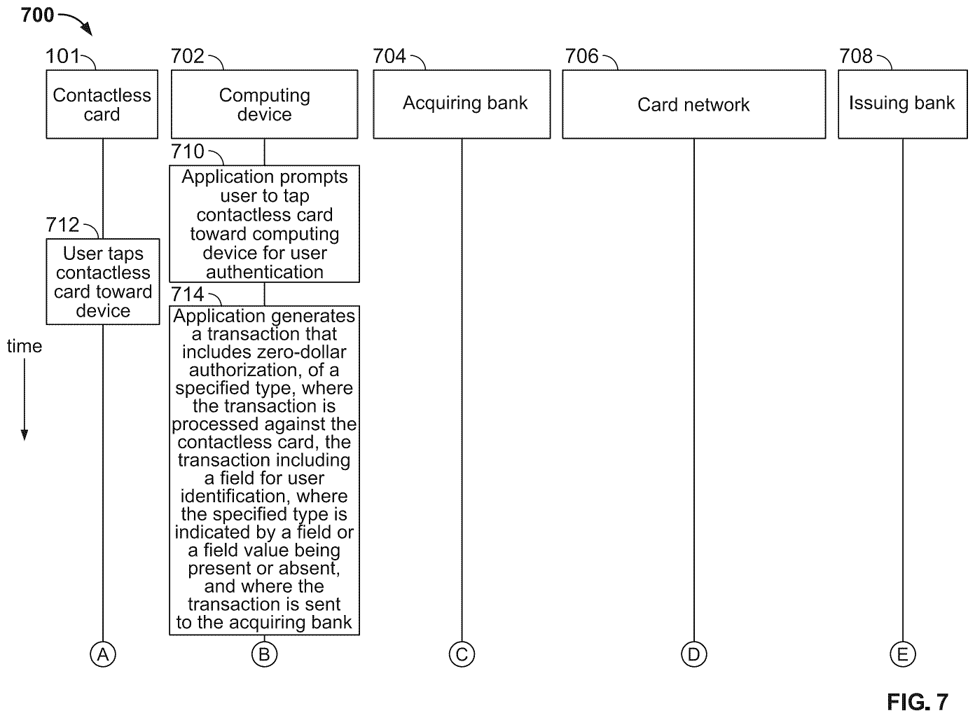

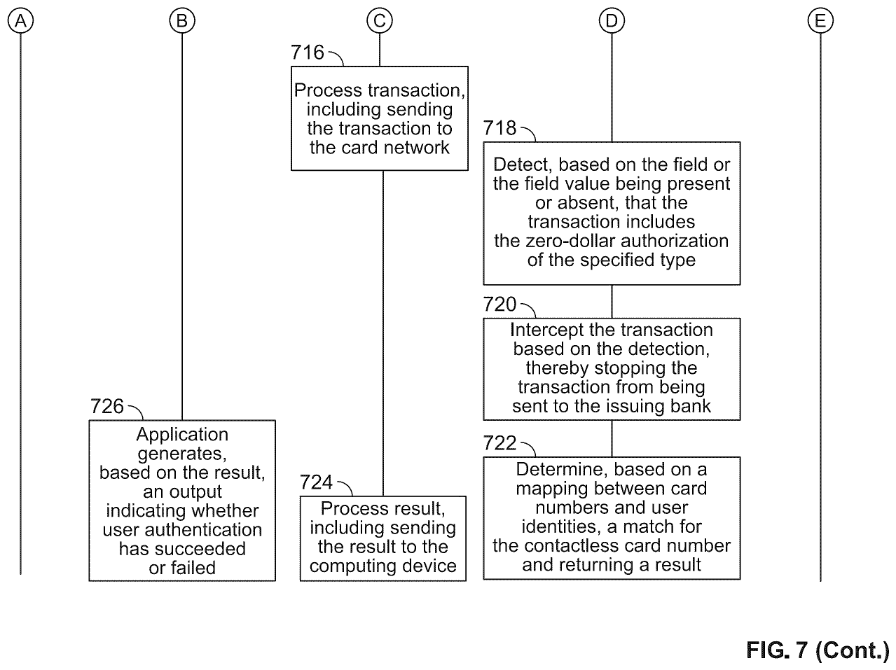

As discussed below in FIG. 7-FIG. 10, any one of the payment processor system 106, acquiring entity system 108, card network system 110, or issuing bank system 112 is configured to identify a flag indicating the authorization request with the contactless card information to authenticate the information. For example, in the system 100, a customer initiates an authentication request by tapping their contactless card on the merchant's POS terminal or a mobile device. The point-of-sale system 102 or mobile device receives contactless card information, such as encrypted data (cryptogram) and non-encrypted data, e.g., a personal account number (PAN), via one or more wireless communication, e.g. near-field communication (NFC) messages. The point-of-sale system 102 or mobile device processes the data from the contactless card 101.

Specifically, the point-of-sale system 102 or mobile device (or online system 104 via the mobile device) generates a test or zero-dollar authentication transaction to communicate in the system 100. In one example, a mobile merchant application on the point-of-sale system 102, the mobile device, or online system 104 triggers or generates a $0 authorization request against the contactless card 101.

The authorization request includes a specific flag indicating a request for authentication or customer identification rather than a standard purchase transaction. The authorization request includes a specific flag indicating a request for authentication or customer identification rather than a standard purchase transaction, e.g., within this authorization request, a particular data field or marker is included to signal its unique purpose. The special flag explicitly indicates that the request is for authentication or customer identification rather than for authorizing a purchase or payment. The flag can be a specific bit/byte set in the transaction data, an additional field, or a pre-defined value in an existing field that payment networks and systems recognize as denoting a non-monetary identification request. The transaction request, now marked with this special customer identification flag, is routed through the payment infrastructure and may be intercepted by any one of the systems to perform an authentication of the user.

In some embodiments, the payment processor system 106, like Visa's network, is programmed to detect and interpret the flag appropriately, distinguishing it from regular purchase transactions. The payment processor system 106 examines the incoming authorization request and identifies the special flag. The payment processor system 106, instead of forwarding the request to the issuing bank for fund checking, performs an authentication via information with the request. This prevents unnecessary fund checks and potential impacts on the card's available balance or credit.

The payment processor system 106 then initiates and performs the process of matching information, such as the PAN, to the cardholder's identity using its secure databases, e.g., performs a lookup using the PAN. The payment processor system 106 returns identity information. For example, the payment processor system 106 upon successfully matching the card number to the cardholder's identity, the payment processor system 106 securely returns this information to the mobile device, including the mobile merchant application, the point-of-sale system 102, and/or the online system 104. The response includes essential details, e.g., the person's identity, name, address, etc. that the merchant application requires to verify the customer's identity and possibly proceed with further steps in the process, e.g., enable access to an account, perform a transaction, allow access to sensitive information, etc. This special-flag mechanism allows the system to efficiently handle customer identification requests separately from purchase transactions, ensuring a streamlined and secure process without confusing or overloading the authorization systems designed primarily for financial approval. Further, the presence of the physical card, validated by the initial tap, provides an additional layer of security. Tapping the card ensures the physical presence of the card, adding a layer of security beyond entering card details manually. This process inherently proves possession of the card, mitigating risks associated with card-not-present fraud.

In some embodiments, other systems, such as the acquiring entity system 108, the card network system 110, and the issuing bank system 112, of the system 100 may perform the authentication lookup and return a result. In embodiments, the system performing the authentication encrypts the result using a encryption algorithm and a key scheme, such as public-private key, diversified distributed keys, etc. The receiving device or system may decrypt the result and verify the customer's identity, e.g., by comparison to authentic information.

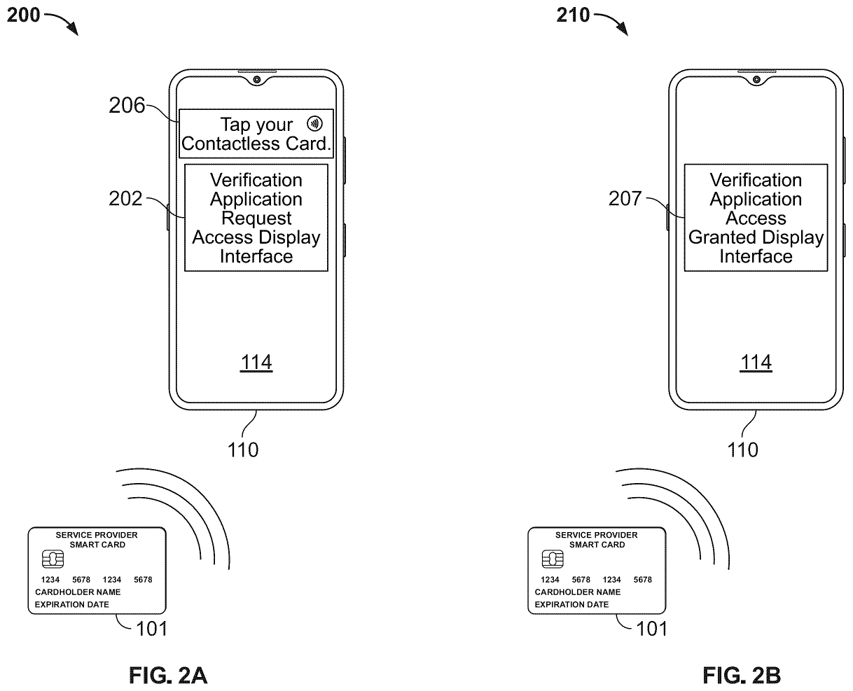

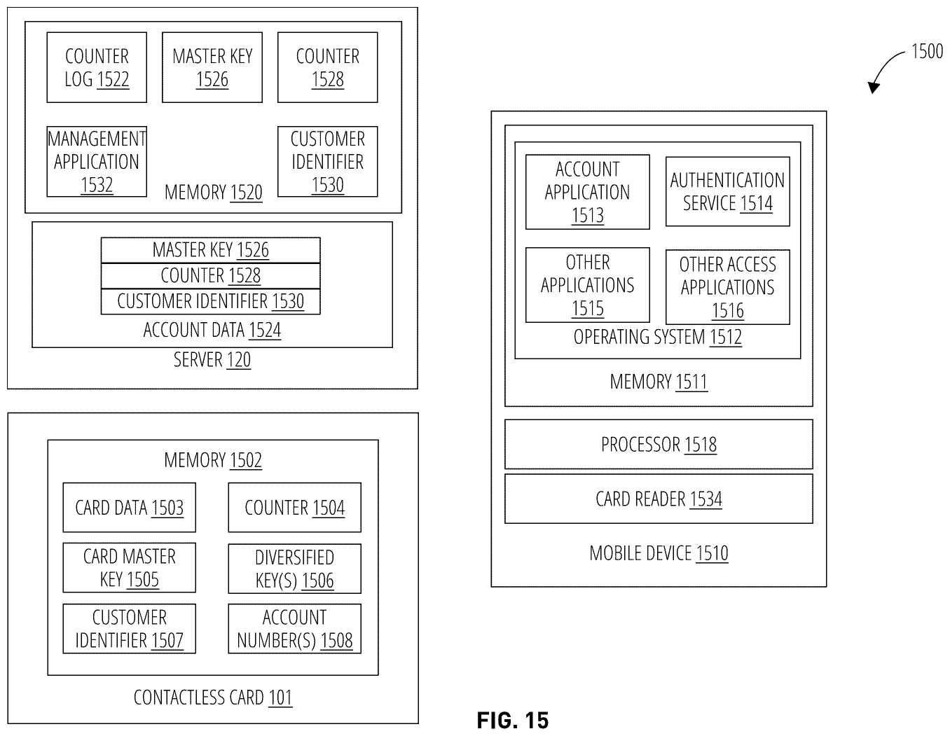

FIG. 2A is a schematic 200 depicting an example embodiment of tapping to initiate a verification or authentication of a user (and/or a contactless card associated therewith) utilizing a payment protocol for purposes distinct from completing a payment. A graphical user interface (GUI) of the authentication service 114 on the mobile device 110 may include a prompt 206 to tap the contactless card 101 to initiate an authentication or verification for another application, e.g. access application 116, where a separate API interface may be provided to communicate the verification or authentication (once completed) to the access application 116 by the authentication service 114. In various embodiments, the access application 116 provides a prompt 202 as a precondition for receiving the tap prompt 206 or after the tap takes place, but prior to any additional verification operations, to enter user credentials for comparison (e.g. as described with reference to FIG. 15) for a first-level and/or second-level of information access in relation to access application 116. In various embodiments, authentication service 114 provides an interface or the prompt 202 for entering the user credential with respect to access application 116 and/or any other application, e.g. other applications 115.

In various embodiments, once the contactless card 101 is tapped to the mobile device 110, the authentication service 114 transmits, via the card reader 1534 (e.g., via NFC, Bluetooth, RFID, etc.), an indication to the contactless card 101. In various embodiments, the indication may specify the performance of one or more encryption techniques as described in FIG. 15. In various embodiments, the authentication service 114 receives transaction or communication data from the server 120. In various embodiments, a specified authentication technique is used, and the authentication service 114 and the contactless card 101 utilize public/private key encryption techniques to authenticate the contactless card 101 and/or the user associated therewith. In various embodiments, the prompt to transmit data between the contactless card 101 and the mobile device 110 may specify to transmit the data to the authentication service 114 via any suitable protocol consistent with an EMV protocol or standard, where in various embodiments the authentication service 114 receives any suitable data directly from the contactless card 101 via a protocol consistent with an EMV protocol or standard. In various embodiments, the tapping may be associated with one or both of a first-level and a second-level information access as described herein, where the first tap results in a comparison of a first and/or a second user and/or additional user credential information prior to instituting a verification and/or authentication technique.

FIG. 2B is a schematic 210 depicting an example embodiment of tapping to initiate a verification or authentication of a user utilizing a payment protocol for purposes distinct from completing a payment. Whether a verification or authentication that includes utilizing a server 120 is used to perform the authentication or verification of the contactless card 101 and/or the user associated therewith, a message 207 indicating that access to the access application 116 is granted may appear on the GUI of the mobile device 110. In various embodiments, access is granted without a message prompt.

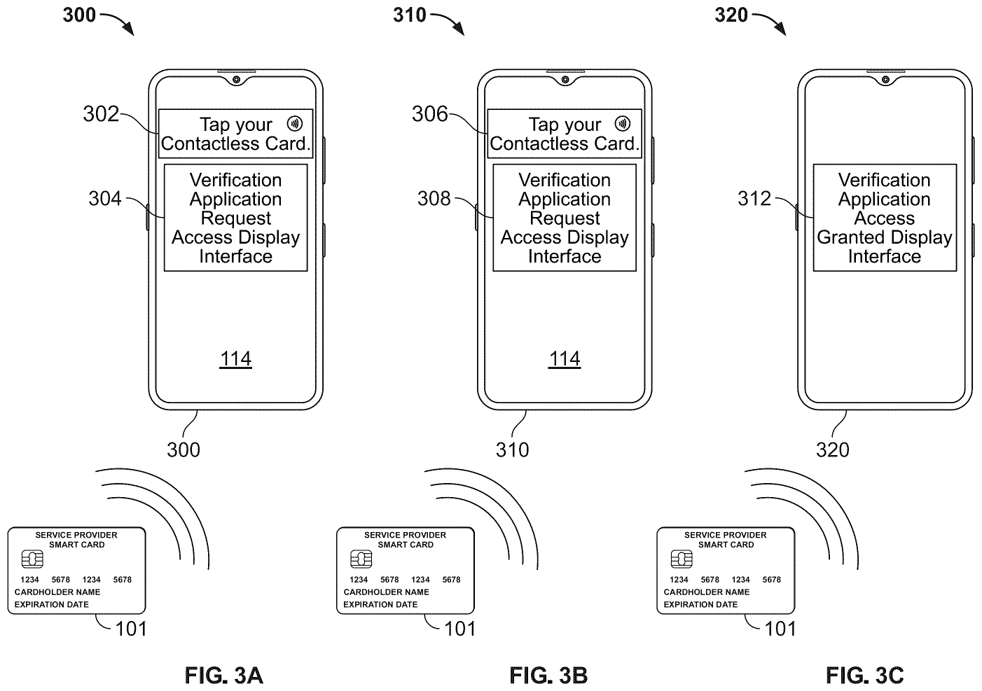

FIG. 3A is a schematic 300 depicting an example embodiment of tapping to initiate a verification or authentication of a user (and/or contactless card associated therewith) utilizing a payment protocol for purposes distinct from completing a payment. Generally, FIG. 3A to FIG. 3C reflect various embodiments where successive taps are used to grant a first-level of information associated with an application and a second-level information of associated with an application in turn associated with a contactless card and/or a user associated with the contactless card and application.

As similarly described with reference to FIG. 2A, a graphical user interface (GUI) of the authentication service 114 on the mobile device 110 may include a prompt 302 to tap the contactless card 101 to initiate an authentication or verification for another application, e.g. access application 116, where a separate API interface may be provided to communicate the verification or authentication (once completed) to the access application 116 by the authentication service 114. In various embodiments, the access application 116 provides a prompt 304 prior to or as a precondition to the tap prompt 302, or immediately after the tap is made, but before any additional verification or authentication operations are performed, to enter user credentials for comparison (e.g. as described with reference to FIG. 15 and FIG. 2A) for a first-level of information access in relation to access application 116. In various embodiments, authentication service 114 provides an interface or prompt 304 for entering the user credential with respect to access application 116 and/or any other application, e.g. other applications 115. Once the contactless card 101 is tapped to the mobile device 110, the authentication service 114 transmits, via the card reader 1534 (e.g., via NFC, Bluetooth, RFID, etc.), an indication to the contactless card 101. In various embodiments, the indication may specify to perform one or more encryption techniques as described with respect to FIG. 15 and FIG. 2A. In various embodiments, a prompt 304 is provided by an application, e.g. access application 116 or authentication service 114. The prompt 304 may be initiated, as already stated, in response to tapping the contactless card on the mobile device 110 or as a precondition to the tap being effective.

In various embodiments, as similarly discussed with reference to FIG. 15 and FIG. 2A, a first application user credential, which may include biometrics data, an established gesture associated with user recognition, a username and password combination, and/or the like, is compared, e.g. by a processor 119 of the mobile device 110, to a stored second application user credential. The stored second application user credential may be associated with the user identity and it may be stored either in the memory 111 of mobile device 110, the memory 102 of the contactless card, or in the memory 122 of the server 120. In various embodiments, as noted above, upon determining a first match between the first application user credential and the stored second application user credential, the authentication service 114 may grant the user access to one or more first-level user account options of a user account. As noted above, the user account may be a financial account, a health insurance account, and/or any other account of the like associated with any service provider (e.g., a transit account, an entertainment account, etc.). Once verified, the user may access certain first-level user account options. The first-level user account options of a user account may include a display of an account balance, a display of recent events or communications, and/or the like. The first-level verification may also be a precondition for initiating a specified authentication or verification technique.

In various embodiments, once the first-level authentication takes place, a specified authentication occurs, in which the authentication service 114 receives event or communication data from the server 120. In various embodiments, the prompt to transmit data between the contactless card 101 and the mobile device 110 may specify to transmit the data to the authentication service 114 via any suitable protocol consistent with and EMV protocol or standard, where in various embodiments the authentication service 114 receives any suitable data directly from the contactless card 101 via a protocol consistent with an EMV protocol or standard.

As discussed in more detail with respect to FIG. 3B, once the authentication or verification technique is completed, a second prompt to tap the card again may be initiated, where the second tap initiates another user credential comparison to grant second-level access to an application associated with a user (and/or a contactless card related thereto) and to perform a second authentication or verification of the user (and/or a contactless card related thereto) in relation to the application.

FIG. 3B is a schematic 310 depicting an example embodiment of tapping to initiate a verification or authentication of a user utilizing a payment protocol for purposes distinct from completing a payment. In various embodiments, a prompt. As similarly described with reference to FIG. 15, FIG. 2A and FIG. 3A, a graphical user interface (GUI) of the authentication service 114 on the mobile device 110 may include a prompt 306 to tap the contactless card 101 to initiate an authentication or verification for another application, e.g. access application 116, where a separate API interface may be provided to communicate the verification or authentication (once completed) to the access application 116 by the authentication service 114. In various embodiments, the prompts 306 and 308 associated with schematic 320 are available only after first-level authentication has occurred and a verification or authentication as outlined in FIG. 3A takes place, and the tap associated with schematic 320 would be a second tap of the contactless card 101 on mobile device 110. In various embodiments, the access application 116 provides a prompt 302 as a precondition for receiving the second tap prompt 306 or after the tap takes place, but prior to any additional verification operations, to enter user credentials for comparison (e.g. as described with reference to FIG. 15) for a second-level of information access in relation to access application 116. The second-level of information is an additional access of more sensitive information that may be provided in addition to the first-level access described in FIG. 3A, where the types of information and applications associated therewith have been described with reference to at least one of FIG. 15, FIG. 2A, and FIG. 3A. In various embodiments, authentication service 114 provides an interface or the prompt 308 for entering the user credential with respect to access application 116 and/or any other application, e.g. other applications 115.

As similarly described with reference to FIG. 15, FIG. 2A and FIG. 3A, once the contactless card 101 is tapped to the mobile device 110, the authentication service 114 transmits, via the card reader 1534 (e.g., via NFC, Bluetooth, RFID, etc.), an indication to the contactless card 101. In various embodiments, the indication may specify to perform one or more encryption techniques as described with respect to FIG. 15, except that, in various embodiments, if a first verification technique utilizing server 120 was employed with respect to FIG. 3A, a second verification technique is performed with respect to FIG. 3B, and vice versa. Once verified purusant to the additional verificaiton technqiue initiated in association with the second tap, the user may access certain second-level user account options. In various embodiments, in similar fashion as discussed in relation to the embodiments described herein, the processor 119 compares at least a portion of the user identity with at least a portion of the cardholder identification information, which may be located in the memory 102 of the contactless card 101, the memory 122 of the server, and or the memory 111 of the mobile device 110. In various embodiments, a second match grants the user access to second-level user account options of a user account (e.g. a card activation, a personal identification number (PIN) change request, and an address change request). In various embodiments, the second-level user account options represent more secured features of the access application 116.

In various embodiments, once the first-level authentication takes place, an authentication technique is used, and the authentication service 114 receives event or communication data from the server 120. In various embodiments, the prompt to transmit data between the contactless card 101 and the mobile device 110 may specify to transmit the data to the authentication service 114 via any suitable protocol consistent with and EMV protocol or standard, where in various embodiments the authentication service 114 receives any suitable data directly from the contactless card 101 via a protocol consistent with an EMV protocol or standard.

FIG. 3C is a schematic 320 depicting an example embodiment of tapping to initiate a verification or authentication of a user utilizing a payment protocol for purposes distinct from completing a payment. Once one or more verification techniques, which may include utilizing one or more of the mobile device 110, the card reader 1534, the contactless card 101 and the server 12, are employed and completed, where in various embodiments the techniques are completed in response to a first and second tap as described with respect to FIG. 3A and FIG. 3B and for a first-level and second-level access, a message 312 indicating that access to the access application 116, including both the first-level and second-level information or features, is granted may appear on the GUI of the mobile device 110. In various embodiments, access is granted without a message prompt.

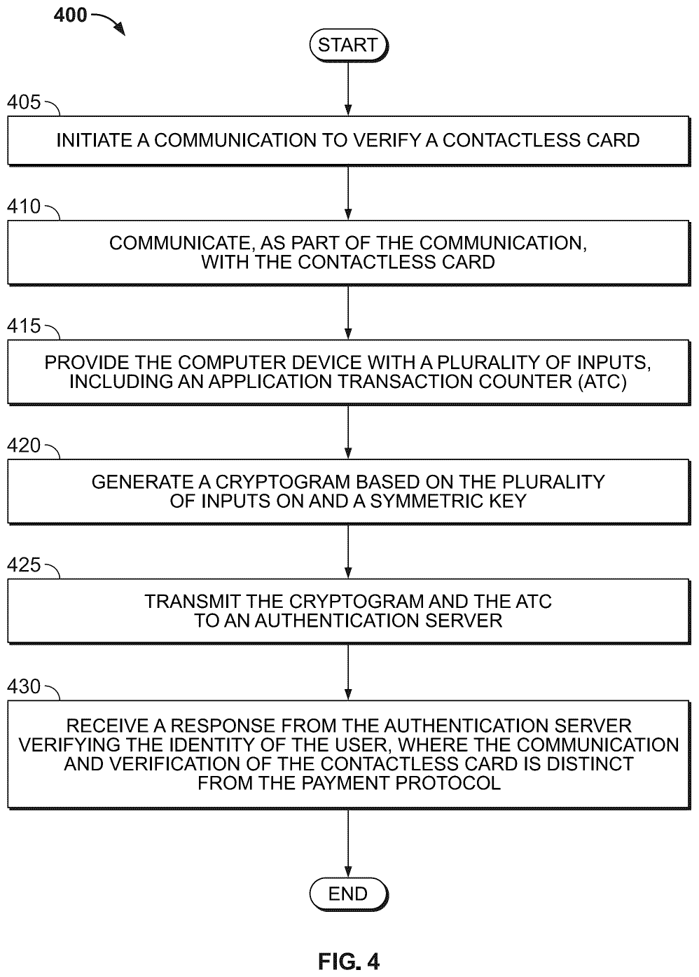

FIG. 4 illustrates an embodiment of a logic flow 400. The logic flow 400 may be representative of some or all of the operations executed by one or more embodiments described herein. For example, the logic flow 400 may include some or all of the operations to verify or authenticate a user utilizing a specified authentication payment technique, but at least in part for purposes distinct than for completing a payment, consistent with an EMV standard. Embodiments are not limited in this context.

As shown, the logic flow 400 begins at block 405, where at least one of the authentication service 114, the OS 112, the management application 1532, and/or any other suitable application may initiate a transaction, event or communication to verify a contactless card, and in various embodiments, by extension thereto, an identity of a user associated with the contactless card 101. In various embodiments, the verification may commence by tapping the contactless card 101 on the mobile device 110. In various embodiments, the access application 116 provides a prompt with a precondition for receiving the tap prompt or immediately after the tap takes place, but prior to any additional verification operations, to enter user credentials for comparison for a first-level and/or second-level of information access in relation to access application 116, where the nature of the first-level and/or second-level information and/or features are described elsewhere herein. In various embodiments, the user credential is associated with a user profile and entered into an interface provided by the mobile device 110, where as stated, the first application user credential may include biometrics data, an established gesture associated with user recognition, a username and password combination, and/or the like. The first application user credential may be transmitted by the authentication service 114 to the management application 1532 of the server 120, where the first application user credential is compared to a stored second credential.

At block 410, and pursuant to various embodiments, if a match is found, a communication between the mobile device 110 and the contactless card 101 is initiated, where the communication utilizes a card reader 1534 and where the communication is based on an NFC protocol. In various embodiments, instead of sending the first application credential for comparison at the server 120, the comparison is done between the mobile device 110 and the contactless card 101, where the stored second credential is stored in a memory 102 of the contactless card. In various embodiments, the comparison with respect to the user credential is omitted, and a tap of the contactless card 101 on the mobile device 110 initiates a prompt to select which application requires authentication, e.g. access application 116, and the NFC communication between the contactless card 101 and the mobile device 110 commences to initiate a verification or authentication of a user using a payment protocol consistent with an EMV standard, but for purposes that include a verification or authentication for purposes other than merely completing a sale or purchase. In various embodiments, either the tap or the user credential comparison may be a precondition for the tap or the user credential comparison to occur, and by extension, serve a precondition for the rest of the flow associated with flow 400.

At block 415, and pursuant to various embodiments, the contactless card 101 may provide the mobile device 110, by the communication with the card and as part of the transaction, event or communication, with one or more inputs, including an application transaction counter (ATC) and at block 420, the contactless card 101 in communication with the mobile device 110 may generate a cryptogram, such as an ARQC, based on the plurality of inputs of the transaction, event or communication and a symmetric key associated with the card. In various embodiments, blocks 415 and 420 may be combined into a single or concurrent sequence. In various embodiments, the operations may run separately. In various embodiments, the receipt of inputs by the mobile device 110 and the generation of the cryptogram by the contactless card may involve one or more operations. The operations may involve that the authentication service 114 may transmit an indication to the contactless card 101 via the NFC card reader 1534 specifying to generate and transmit encrypted data. The operations may further include that the contactless card 101 may increment the counter value 104 in the memory 102 responsive to receiving the indication to generate encrypted data. The operations may further include that the contactless card 101 generate the diversified key 106 using the counter value 104 and the master key 105 in the memory 102 and a cryptographic algorithm. The operations may further include that the contactless card 101 encrypts data (e.g., the customer identifier 107) using the diversified key 106 and the cryptographic algorithm, generating encrypted data (e.g., the cryptogram 134). The operations may further include that the contactless card 101 may transmit the encrypted data to the authentication service 114 of the mobile device 110, e.g., using NFC. In various embodiments, the contactless card 101 further includes an indication of the counter value 104 along with the encrypted data.

At block 425, the authentication service 114 of the mobile device 110 may transmit the data received from the contactless card 101 to the management application 1532 of the server 120 (which may be associated, as stated above, with the issuer of the contactless card 101). At block 430, the mobile device 110 may receive a response from the issuer by the server 120 verifying the contactless card, and/or the identity of the user as a result therewith, based on the transmitted cryptogram (and other transmitted information), where the received response is based on recreating the symmetric key and/or the entire cryptogram, e.g. at a server 120 associated with the issuer (generated in party by using the symmetric key), by the issuer, e.g. authentication server of the issuer, in response to receiving the cryptogram. In various embodiments, one or more operations are associated with block 425. The operations may include that the management application 1532 of the server 120 generate a diversified key 106 using the master key 105 and the counter value 104 as input to a cryptographic algorithm. In various embodiments, the management application 1532 uses the counter value 104 provided by the contactless card 101. In various embodiments, the management application 1532 increments the counter value 104 in the memory 122 to synchronize the state of the counter value 104 in the memory 122 with the counter value 104 in the memory 102 of the contactless card 101. Accordingly, in various embodiments, not only is the user (and/or contactless card) verified, but the counter, e.g. an ATC, is synchronized between the contactless card 101 and the server 120, which may mitigate errors in processing subsequent transactions, events or communications.

In various embodiments, the above operations and blocks associated with FIG. 4 are consistent with an EMV standard, and the generate cryptogram and the received response associated therewith are part of a payment protocol, except that when initiated by the access authentication service 114, the verification and authentication derived from executing the payment protocol were for purposes distinct from completing a payment, e.g. acquiring access to one or more non-payment features of access application 116.

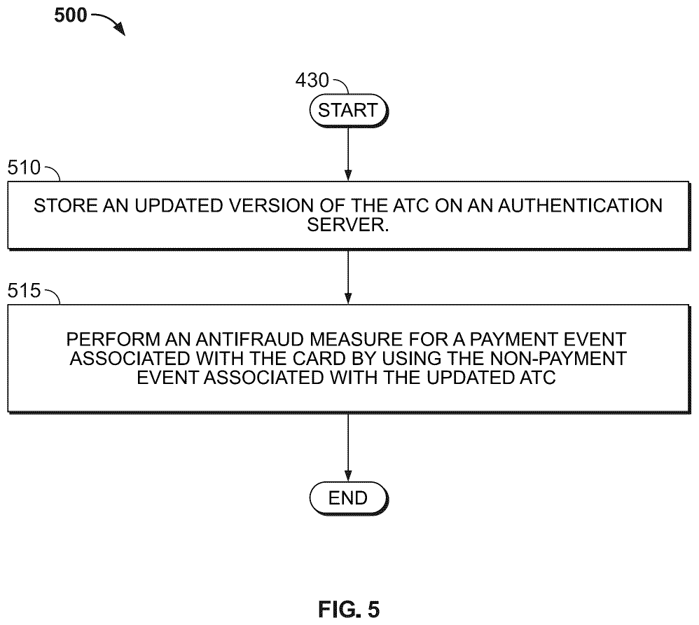

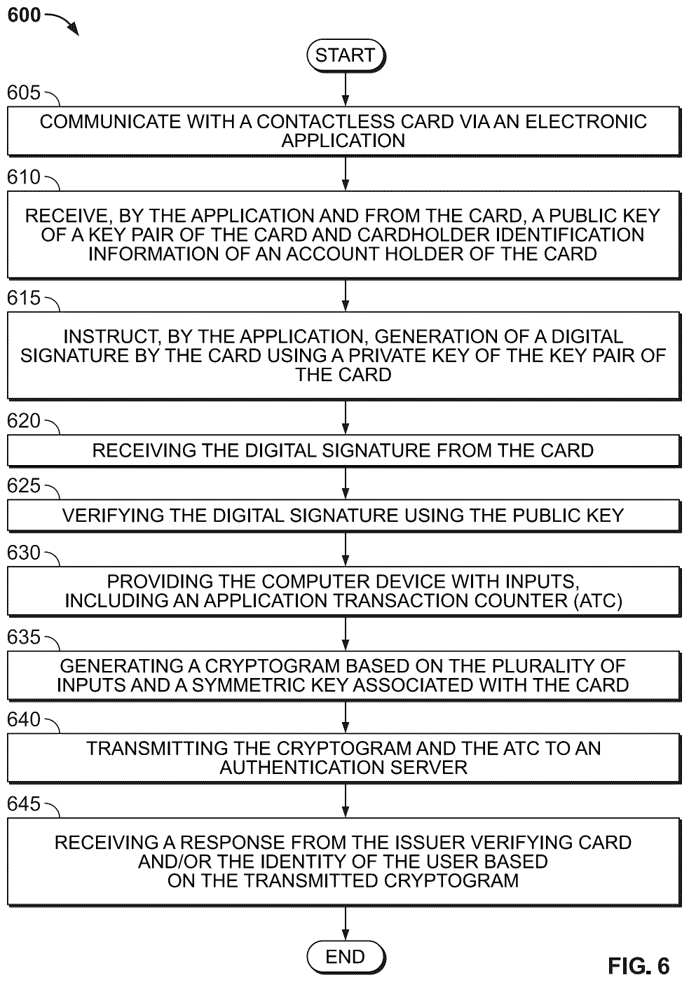

FIG. 5 illustrates an embodiment of a logic flow 500. The logic flow 500 may be representative of some or all of the operations executed by one or more embodiments described herein. For example, the logic flow 500 may include utilizing an updated ATC associated with the verification or authentication operations of FIG. 4 in order to perform an antifraud measure. Embodiments are not limited in this context.

As shown, the logic flow 500 begins after one or more operations of FIG. 4 are completed, where in various embodiments, the flow begins at block 430 of FIG. 4. At block 510, an updated version of the ATC is stored on the host device associated with the issuer, e.g. server 120. Accordingly, in various embodiments, flow 500 is associated with at least one embodiment of FIG. 4 where the ATC is stored in counter log 121 of the sever 120 and there is a synchronization between the ATC of the contactless card 101 and the ATC stored at the server 120. At block 515, an antifraud measure may be performed by the server 120 utilizing the ATC. In various embodiments, counter log 121 may include time stamps associated with the counter value associated with one or more non-payment event or communication, where the time stamps may be logged by an internal counter or timing device of the sever 120 communicating with the management application 1532, and where the management application 1532 logs the timing of the event or communication utilizing a timing or clock device. In various embodiments, the counter log 121 may include time stamps associated with the counter value associated with one or more payment events or communications, where again the time stamps may be logged by an internal counter or timing device communicating with the management application 1532, and where the management application 1532 logs the timing of the event or communication utilizing a timing or clock device. In various embodiments, the counter value of the ATC in relation to a particular event or communication, e.g. whether it is a payment event or communication or a non-payment event or communication, may also be logged by the management application 1532. In various embodiments, the management application 1532 may be configured to recognize any event or communication stemming from authentication service 114 as a non-payment event or communication, irrespective of its particular nature, and any other event or communication utilizing the user's credentials as a payment event or communication. Alternatively, the management application 1532 may utilize the first-level and second-level user credential scheme outlined herein as a mechanism for determining when an event or communication is a payment or non-payment event or communication, e.g. if an event or communication utilizes an operation of the server 120 to perform an authentication and if both a first-level and second-level of access is granted, then it is a payment event or communication, otherwise it is a non-payment event or communication. Any other suitable technique may be used to distinguish and log an event or communication as a payment event or communication or non-payment event or communication.

In various embodiments, as noted above, the management application 1532 may be configured to compare a general number of payment events or communications that take place in between non-payment events or communications. If the number of payment events or communications after a non-payment event or communication exceeds a certain threshold, the management application 1532 may deny the payment events or communications, even if otherwise the event or communication may be completed (e.g. since it is assumed that a user may use the payment protocol for non-payment and payment protocol, an unduly large number of payment events or communications after a non-payment events or communications may be considered fraudulent). In various embodiments, the opposite may be implemented, e.g. a large number of non-payment events or communications being performed after a payment event or communication in excess of a threshold may cause the management application 1532 to deny a certain non-payment event or communication when the verification or authentication takes place. In various embodiments, a threshold in relation to time between any event or communication, e.g. payment or non-payment, in terms of exceeding a minimum or maximum threshold may cause the management application 1532 to deny the authentication or verification operation. The counter log 121 may be used to perform any other suitable operation, including performing an anti-fraud measure in any other suitable manner.

FIG. 7 is a sequence diagram depicting a routine 700 that can be representative of some or all of the operations executed according to one or more embodiments described herein. For example, the routine 700 can include some or all of the operations for authentication based on the contactless card 101. In one embodiment, the routine 700 is performed using one or more of the contactless card 101, an application on the computing device 702, an application of the acquiring bank 704, an application of the card network 706, and an application of the issuing bank 708.

In a particular embodiment, the application on the computing device 702 is a merchant application, such as a mobile merchant application if the computing device is a mobile device. Additionally or alternatively, one or more of the applications of the acquiring bank 704, the card network 706, and the issuing bank 708 can be a server of one or more types, e.g., an authentication server and/or a transaction processing server. Further, the computing device 702 can correspond to the mobile device 110 of FIG. 15. Embodiments are not limited in this context, however.

As shown, the routine 700 begins in block 710, where the application on the computing device 702 prompts a user to tap the contactless card 101 toward the computing device 702 for user authentication. In block 712, the user taps the contactless card 101 toward the computing device 702 in response to the prompting. In block 714, the application on the computing device 702 detects the tap of the contactless card 101 and generates a transaction that includes a zero-dollar authorization of payment.

In embodiments where multiple types of zero-dollar authorization are supported, the zero-dollar authorization can be a specified type of the multiple types. Otherwise, the zero-dollar authorization need not necessarily have a type per se. The transaction is processed against the contactless card 101, and the transaction includes a field for user identification.

In some embodiments, the field can contain a value such as a contactless card number. The contactless card number can be a credit card number when the contactless card is a credit card. Alternatively, in scenarios where it is desired to avoid including the credit card number verbatim in the transaction, such as to increase security, the contactless card number can an alternative number, which is characterized as a pre-assigned number than can be mapped to the credit card number. The mapping between the alternative numbers and the credit card numbers can be performed based on a predetermined mapping table between credit card numbers and alternate numbers. The mapping can be performed by an intercepting entity as described herein. Alternatively, the mapping can be performed by any entity that processes a transaction before the transaction is processed by the intercepting entity.

In one embodiment, the specified type, if it is present, is indicated by a field or a field value being present or absent in the transaction. The application of the computing device 702 sends the transaction to the application of the acquiring bank 704. In block 716, the application of the acquiring bank 704 processes the transaction, including sending the transaction to the application of the card network 706.

In block 718, the application of the card network 706 detects, based on the field or the field value being present or absent in the transaction, that the transaction includes the zero-dollar authorization. The application of the card network 706 can optionally also determine that the zero-dollar authorization is a zero-dollar authorization of a specified type of multiple types of zero-dollar authorizations, in some embodiments. In block 720, the application of the card network 706 intercepts the transaction based on the detection, which stops the transaction from being sent to the application of the issuing bank 708 or, in some embodiments, to any application of the issuing bank 708. In block 722, the application of the card network 706 determines a match for the contactless card number and returns a result.

Depending on the embodiment, the result can include either information pertaining to the match or an indication of whether a match is found to be present or absent. At least in some embodiments, if a match is found, then the application of the card network 706 proceeds to authenticate the user of the computing device 702, resulting in a successful authentication. At least in such embodiments, if no match is found, the application of the card network 706 denies the user of the computing device 702 from being authenticated. This results in a failed authentication.

In block 724, the application of the acquiring bank 704 processes the result received from the application of the card network 706, including sending the result to the computing device 702. In other embodiments, the card network 706 can return the result to the computing device 702 directly, thereby bypassing the acquiring bank 704 when returning the result. In some embodiments, regardless of whether the acquiring bank 704 is bypassed when returning the result, in block 725 the application of the computing device 702 generates an output indicating whether user authentication has succeeded or failed. The output can be generated based on the result received by the application on the computing device 702. After the block 724, the routine 700 ends.

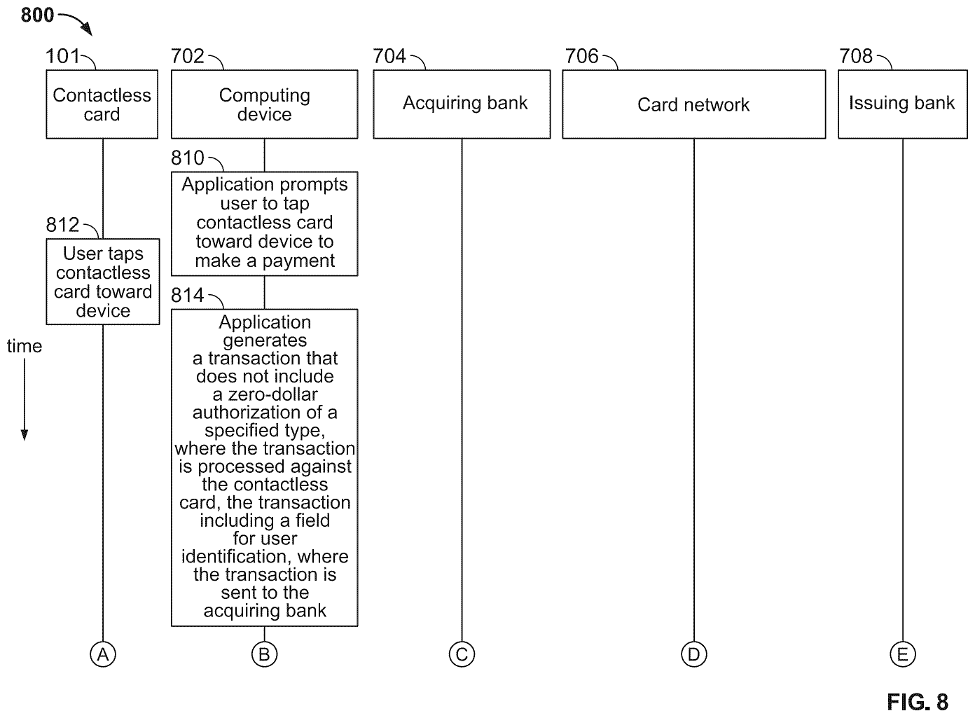

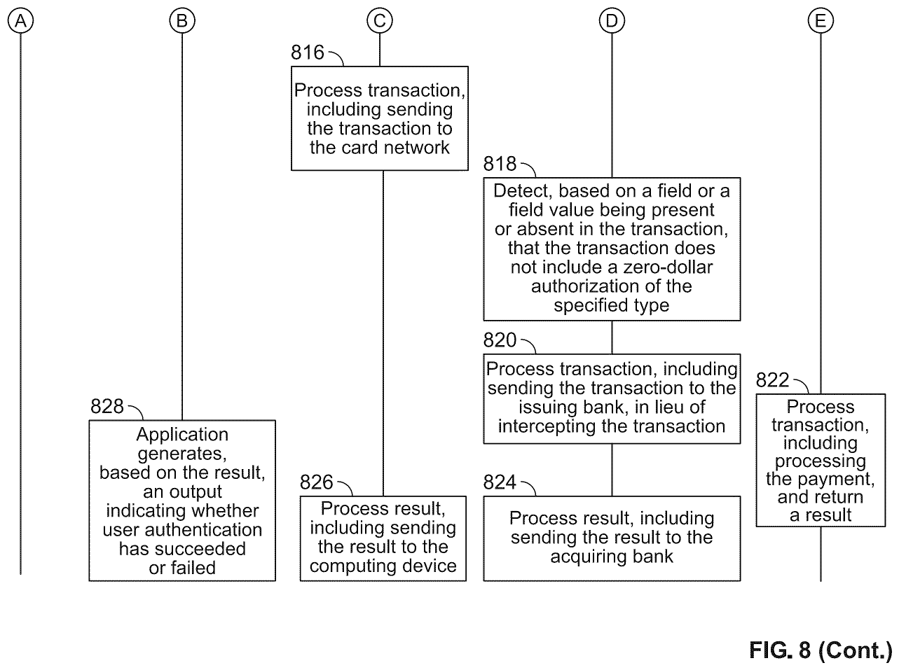

FIG. 8 is a sequence diagram depicting a routine 800 that can be representative of some or all of the operations executed according to one or more embodiments described herein. For example, the routine 800 can include some or all of the operations for authentication based on the contactless card 101. In one embodiment, the routine 800 is performed using one or more of the contactless card 101, the application on the computing device 702, the application of the acquiring bank 704, the application of the card network 706, and the application of the issuing bank 708, and the application on the computing device 702 is a merchant application. Embodiments are not limited in this context, however.

As shown, the routine 800 begins in block 810, where an application on the computing device 702 prompts a user to tap the contactless card 101 toward the computing device 702 to make a payment—e.g., rather than for user authentication as shown in the previous figure. In block 812, the user taps the contactless card 101 toward the computing device 702 in response to the prompting. In block 814, the application on the computing device 702 detects the tap of the contactless card 101 and generates a transaction that does not include any zero-dollar authorization of payment. If different types are supported, the generated transaction does not include any zero-dollar authorization of payment of any type.

The transaction is processed against the contactless card 101, and the transaction includes a field for user identification. Absence of the zero-dollar authorization is indicated by a field or a field value being absent or present in the transaction. The application of the computing device 702 sends the transaction to the application of the acquiring bank 704. In block 816, the application of the acquiring bank 704 processes the transaction, including sending the transaction to the application of the card network 706.

In block 818, the application of the card network 706 detects, based on the field or the field value being absent or present in the transaction, that the transaction does not include a zero-dollar authorization. In block 820, the application of the card network 706 processes the transaction, including sending the transaction to the application of the issuing bank 708, in lieu of intercepting the transaction and in lieu of determining a match for the contactless card number based on the mapping (as shown in the previous figure).

In block 822, the application of the issuing bank 708 processes the transaction, including processing the payment, and returns a result to the application of the card network 706. In block 824, the application of the card network 706 processes the result, including sending the result to the application of the acquiring bank 704. In block 826, the application of the acquiring bank 704 processes the result, including sending the result to the application of the computing device 702. In block 828, the application on the computing device 702 generates, based on the result, an output indicating whether user authentication has succeeded or failed.

In other embodiments, one or more of the acquiring bank 704 and the card network 706 can be bypassed when returning the result from the issuing bank 708 to the computing device 702. For instance, the issuing bank 708 can return the result directly to the computing device 702, thereby bypassing both the acquiring bank 704 and the card network 706 when returning the result. Alternatively, only the acquiring bank 704 is bypassed, or only the card network 706 is bypassed. After the block 828, the routine 800 ends.

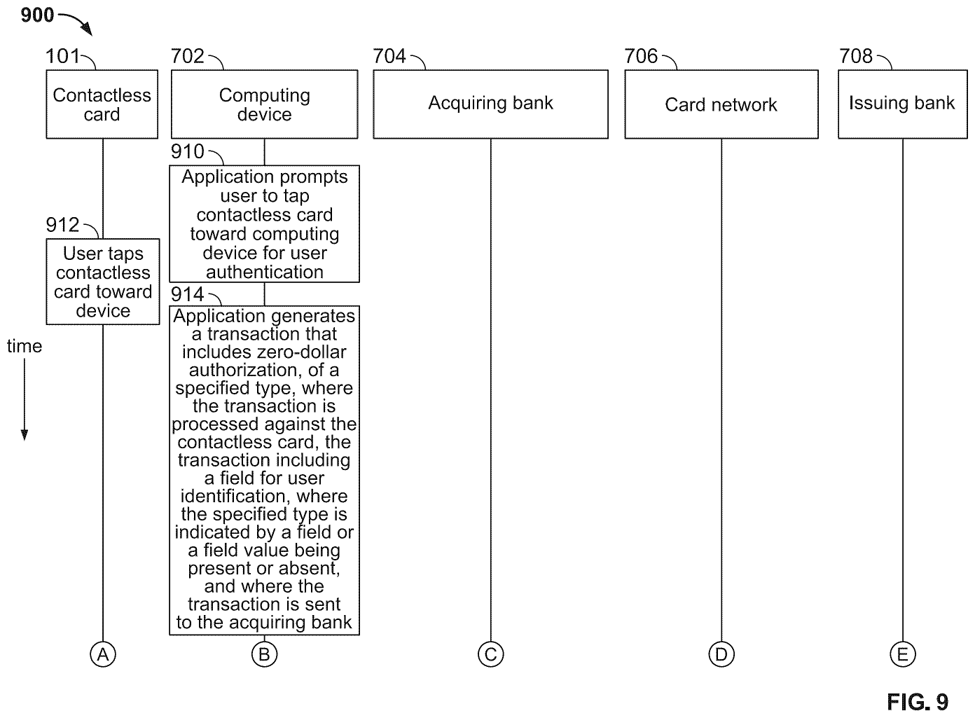

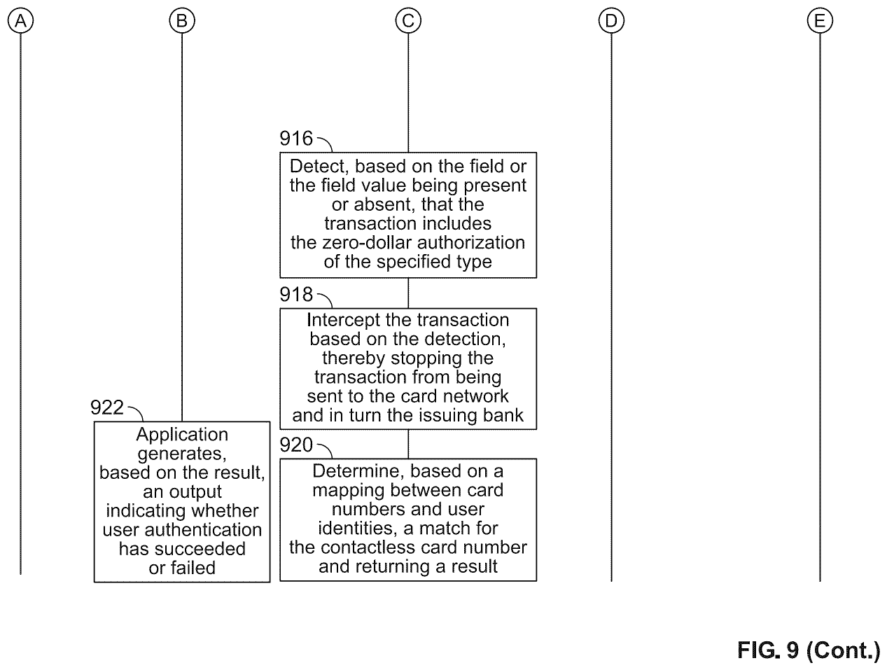

FIG. 9 is a sequence diagram depicting a routine 900 that can be representative of some or all of the operations executed according to one or more embodiments described herein. For example, the routine 900 can include some or all of the operations for authentication based on the contactless card 101. In one embodiment, the routine 900 is performed using one or more of the contactless card 101, the application on the computing device 702, the application of the acquiring bank 704, the application of the card network 706, and the application of the issuing bank 708.

In a particular embodiment, the application on the computing device 702 is a merchant application, such as a mobile merchant application if the computing device is a mobile device. Additionally or alternatively, one or more of the applications of the acquiring bank 704, the card network 706, and the issuing bank 708 can be a server of one or more types, e.g., an authentication server and/or a transaction processing server. Further, the computing device 702 can correspond to the mobile device 110 of FIG. 15. Embodiments are not limited in this context, however.

Unlike in the previous two figures, the embodiment shown in FIG. 9 depicts the acquiring bank 704, rather than the card network 706, as being the intermediary that intercepts a transaction having a zero-dollar authorization. As shown, the routine 900 begins in block 910, where the application on the computing device 702 prompts a user to tap the contactless card 101 toward the computing device 702 for user authentication. In block 912, the user taps the contactless card 101 toward the computing device 702 in response to the prompting. In block 914, the application on the computing device 702 detects the tap of the contactless card 101 and generates a transaction that includes a zero-dollar authorization of payment. The application of the computing device 702 sends the transaction to the application of the acquiring bank 704.

In block 916, the application of the acquiring bank 704 detects, based on the field or the field value being present or absent in the transaction, that the transaction includes the zero-dollar authorization. The application of the acquiring bank 704 can optionally also determine that the zero-dollar authorization is a zero-dollar authorization of a specified type. In block 918, the application of the acquiring bank 704 intercepts the transaction based on the detection, which stops the transaction from being sent to the card network 706 and, in turn, the issuing bank 708. In block 920, the application of the acquiring bank 704 determines a match for the contactless card number and returns a result.

Depending on the embodiment, the result can include either information pertaining to the match or an indication of whether a match is found to be present or absent. At least in some embodiments, if a match is found, then the application of the acquiring bank 704 proceeds to authenticate the user of the computing device 702, resulting in a successful authentication. At least in such embodiments, if no match is found, the application of the acquiring bank 704 denies the user of the computing device 702 from being authenticated. This results in a failed authentication.

In block 922, the application of the computing device 702 generates an output indicating whether user authentication has succeeded or failed. The output can be generated based on the result received from the application of the acquiring bank 704. After the block 724, the routine 700 ends.

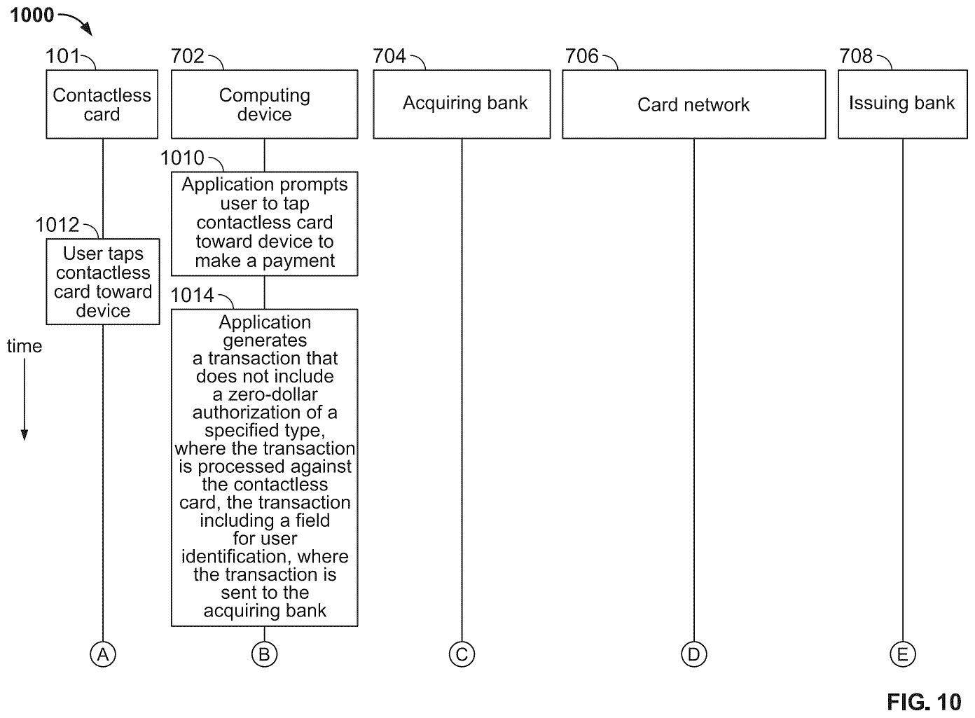

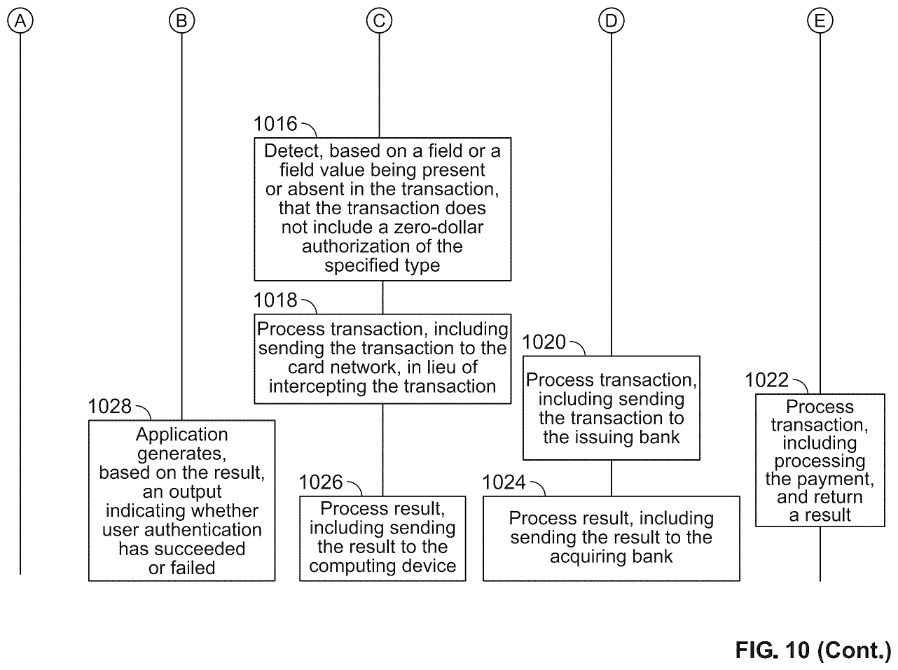

FIG. 10 is a sequence diagram depicting a routine 1000 that can be representative of some or all of the operations executed according to one or more embodiments described herein. For example, the routine 1000 can include some or all of the operations for authentication based on the contactless card 101. In one embodiment, the routine 1000 is performed using one or more of the contactless card 101, the application on the computing device 702, the application of the acquiring bank 704, the application of the card network 706, and the application of the issuing bank 708, and the application on the computing device 702 is a merchant application. Embodiments are not limited in this context, however.

As shown, the routine 1000 begins in block 1010, where an application on the computing device 702 prompts a user to tap the contactless card 101 toward the computing device 702 to make a payment—e.g., rather than for user authentication as shown in the previous figure. In block 1012, the user taps the contactless card 101 toward the computing device 702 in response to the prompting. In block 1014, the application on the computing device 702 detects the tap of the contactless card 101 and generates a transaction that does not include any zero-dollar authorization of payment. If different types are supported, the generated transaction does not include any zero-dollar authorization of payment of any type.

The transaction is processed against the contactless card 101, and the transaction includes a field for user identification. Absence of the zero-dollar authorization is indicated by a field or a field value being absent or present in the transaction. The application of the computing device 702 sends the transaction to the application of the acquiring bank 704.

In block 1016, the application of the acquiring bank 704 detects, based on the field or the field value being absent or present in the transaction, that the transaction does not include a zero-dollar authorization. In block 1018, the application of the acquiring bank 704 processes the transaction, including sending the transaction to the application of the card network 706, in lieu of intercepting the transaction and in lieu of determining a match for the contactless card number based on the mapping (as shown in the previous figure).

In block 1020, the application of the card network 706 processes the transaction, including sending the transaction to the application of the issuing bank 708. In block 1022, the application of the issuing bank 1022 processes the transaction, including processing the payment, and returns a result to the application of the card network 706.

In block 1024, the application of the card network 706 processes the result, including sending the result to the application of the acquiring bank 704. In block 1026, the application of the acquiring bank 704 processes the result, including sending the result to the application of the computing device 702. In block 1028, the application on the computing device 702 generates, based on the result, an output indicating whether user authentication has succeeded or failed.

In other embodiments, one or more of the acquiring bank 704 and the card network 706 can be bypassed when returning the result from the issuing bank 708 to the computing device 702. For instance, the issuing bank 708 can return the result directly to the computing device 702, thereby bypassing both the acquiring bank 704 and the card network 706 when returning the result. Alternatively, only the acquiring bank 704 is bypassed, or only the card network 706 is bypassed. After the block 1028, the routine 1000 ends.

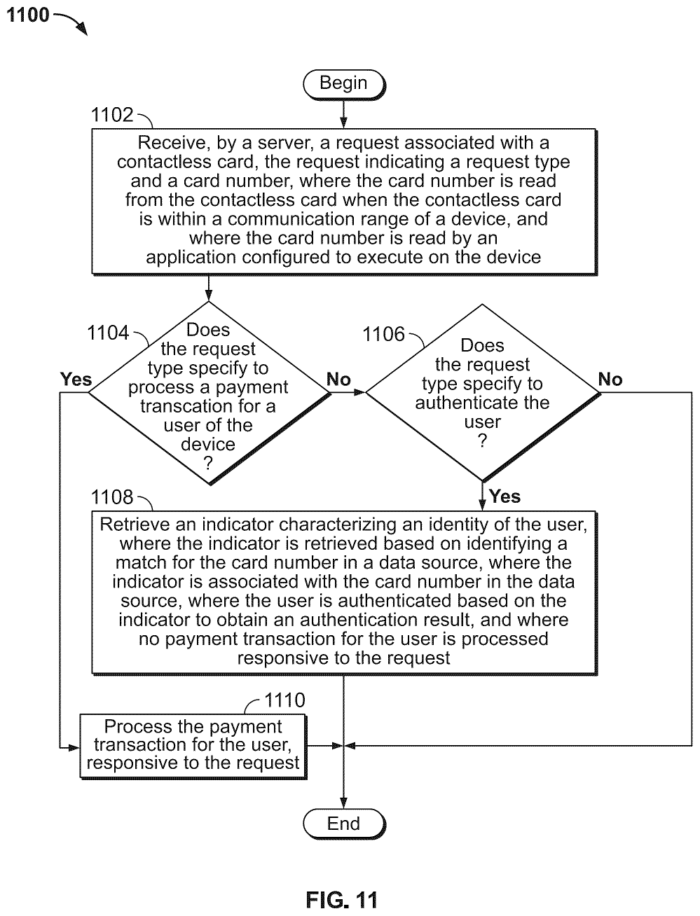

FIG. 11 illustrates an embodiment of a logic flow, or routine, 1100. The routine 1100 can be representative of some or all of the operations executed by one or more embodiments described herein. For example, the routine 1100 can include some or all of the operations for card-based authentication, and some or all of the routine 1100 can be performed by the application of the acquiring bank 704 and/or the application of the card network 706, depending on the embodiment. Embodiments are not limited in this context, however. For clarity, the acquiring bank 704 and the card network 706 are also referred to herein as intermediaries between the computing device 702 and the issuing bank 708. Other intermediaries, such as non-banking intermediaries, are broadly contemplated and can use the techniques disclosed herein.

In block 1102, the application, of the intermediary, when executing the routine 1100 receives a request that indicates a request type and a card number. The card number is read from the contactless card when the contactless card is within a communication range of a device. The card number is read by an application configured to execute on the device. In block 1104, the application of the intermediary determines whether the request type specifies to process a payment for a user of the device. If so, the routine 1100 proceeds to block 110 to process the payment for the user, responsive to the request. Otherwise, in block 1106, the application of the intermediary determines whether the request type specifies to authenticate the user of the device.

If the determination in block 1106 is in the affirmative, then in block 1108, the application of the intermediary retrieves an indicator characterizing an identity of the user. The indicator is retrieved based on identifying a match for the card number in a data source. For instance, the data source can include a mapping between known card numbers and known user identities, and the mapping can reflect an association between the indicator and the card number. The application of the intermediary can then authenticate the user based on the indicator to obtain an authentication result. Responsive to the request, the authentication result is returned, and no payment transaction for the user is processed. After the block 1108 or the block 1110, or if the determination in block 1106 is in the negative, the routine 1100 ends.

Advantageously, by using the techniques disclosed herein, existing contactless payment rails can be used for authentication purposes, by intercepting a transaction having a zero-dollar authorization, denoted by a predefined indicator, and matching the contactless card number to a user identity. Using the scenario of the contactless card being a credit card as an example, the transaction can follow a conventional credit card transaction with an acquiring bank (also referred to as a merchant acquirer), a card network, and an issuing bank. Any of the parties along the way can intercept the transaction and associate the credit card number to a customer identity, provided that the party has a data structure, such as a table, that provides a mapping between credit card numbers and user identities. The interception can be based on a field having a certain value or an additional field being present in the transaction. Alternatively, the interception can be based on a field not being present in the transaction. In either case, when the interception is triggered, the transaction is taken out of the flow among entities, to match the credit card number to the user identity.

In multi-factor authentication (MFA) scenarios involving a knowledge factor (what the user knows) and a possession factor (what the user has), the tapping of the contactless card can serve to indicate that the contactless card is in the possession of the user, e.g., to satisfy the second factor. In some embodiments, the card network can perform some or all of the steps disclosed herein and without requiring the contactless card to actually be tapped in the first place. However, the tapping of the card provides an additional measure of security in the form of requiring the user to physically possess a designated item rather than just requiring the user to input a contactless card number. Mere input of a contactless card number has limited value for authentication purposes and could even lead to vulnerabilities to bad actors using illicitly obtained contactless card numbers to engage in identity theft.

Further, embodiments disclosed herein can provide benefits over alternative approaches that may require one or more specified applets to be added to the contactless card during the manufacturing of the contactless card. Put another way, embodiments disclosed herein can apply to a broader class of contactless cards that may not necessarily have the one or more specified applet or, in some cases, any applet.

Although some approaches enable credit cards to be tapped to a mobile device for payment in lieu of requiring a hardware attachment, such as those associated with a payment processing service vendor, to be connected to the mobile device. However, such approaches pertain to the mobile device of a merchant and not to the mobile device of an end-user. Such approaches effectively internalize merchant-side hardware in the mobile device of the merchant, by using the mobile device of the merchant as a credit card terminal.

Using the zero-dollar authorization as disclosed herein can also circumvent an issue relating to a series of transaction counters, of a series of transactions, that can be deemed by a banking entity based on predefined rules, as being indicative of fraud and used as a basis for automatically rendering a contactless card unusable under a security policy of the banking entity. For instance, the transaction counters can be deemed indicative of fraud of the transaction counters indicate an unexpectedly large number of transactions occurring in a relatively short time frame. The contactless cards can be rendered unusable permanently, indefinitely, or until the user calls and is, at a minimum, successfully authenticated by the banking entity, depending on the embodiment.

In one embodiment, some mobile phone platforms and/or ecosystems may implement safeguards that prevent end-user mobile applications in such platforms/ecosystems to accept credit card taps. Such safeguards may be in place because, for instance, because the vendor of a specific platform or ecosystem may also be a vendor of a payment processing service, such that the vendor may perceive end-user credit card tapping applications as unwanted competition in the marketplace. Even if the vendor, in a reversal of policy, starts to accept credit card taps, using credit card numbers as a reference for customer identity can still have undesirable results, because doing so amounts to a security risk. This is because the credit card numbers are transmitted in unencrypted form for tap detection and can be accessible to any bad actor that can mislead an end-user into tapping his or her contactless card.

Another security risk is that accepting credit card taps allows mobile applications on customer phones to collect contactless card numbers, and the collected numbers can become a target of bad actors to obtain. However, some mobile phone platforms and/or ecosystems already permit end-user applications to read credit card data. Further, approval, on a per-developer basis, by the vendor of the platform and/or ecosystem may not necessarily be required, to read the credit card data. Although any transmitted cryptogram requires decryption at the card network or the issuing bank, which provides a level of security, the contactless card numbers are still transmitted in unencrypted form when tapping, which poses a security risk.

Further, existing payment rails may not necessarily support device binding as a security feature. When using such payment rails for user authentication, the user authentication is performed without the safeguards provided by device binding. Put another way, any bad actor can tap a contactless card, of a certain end-user, to a mobile device of the bad actor and steal the identity of that end-user. To have the safeguards provided by device binding, alternate payment rails, that support device binding features implemented by the card network, are to be used. Such device binding features can be implemented, for instance, in part by the card network providing a software development kit for use in developing applications. In some embodiments, such applications are ones capable of reading data from contactless cards that are tapped toward mobile devices, decrypting the data, and being bound to a given mobile device.

Approaches that in effect involve two possession factors, namely, possession of a given mobile device and possession of a contactless card having a specified applet, respectively, may require significant modification to existing payment rails before the existing payment rails can be used under such approaches. Such extent of modifications can create additional vulnerabilities in the credit card processing ecosystem. And although such approaches can provide a greater measure of security, such approaches are also characterized by a challenge of a lack of adoption. The lack of adoption results from new contactless cards, with the specified applet added during manufacturing of the new contactless cards, being required to be issued. This is because for many end-users, the contactless cards already in the possession of these end-users may not necessarily contain the specified applet and, as such, are not compatible with the approaches requiring the specified applet to be present.

In various embodiments, the contactless card 101 may be tapped to a device, such as one or more computer kiosks or terminals, to verify identity so as to receive a transactional item responsive to a purchase, such as a coffee. By using the contactless card 101, a secure method of proving identity in a loyalty program may be established. Securely proving the identity, for example, to obtain a reward, coupon, offer, or the like or receipt of a benefit is established in a manner that is different than merely scanning a bar card. For example, an encrypted transaction may occur between the contactless card 101 and the device, which may be configured to process one or more tap gestures. As explained above, the one or more applications may be configured to validate identity of the user and then cause the user to act or respond to it, for example, via one or more tap gestures. In various embodiments, data for example, bonus points, loyalty points, reward points, healthcare information, etc., may be written back to the contactless card.

In various embodiments, the contactless card 101 may be tapped to a device, such as the mobile device 110. As explained above, identity of the user may be verified by the one or more applications which would then grant the user a desired benefit based on verification of the identity.

At least some embodiments involve point of sale (POS) systems that submit transactions including a transaction value to a card issuer. Whether the issuer approves or denies the transaction may be based on whether the card issuer recognizes the transaction value. Meanwhile, in certain embodiments of the present disclosure, transactions originating from a mobile device lack the transaction value associated with the POS systems. Therefore, in various embodiments, a dummy transaction value (i.e., a value recognizable to the card issuer and sufficient to allow activation to occur) may be passed as part of the example authentication communication protocol. POS based transactions may also decline transactions based on the number of transaction attempts (e.g., transaction counter). A number of attempts beyond a buffer value may result in a soft decline; the soft decline requiring further verification before accepting the transaction. In some implementations, a buffer value for the transaction counter may be modified to avoid declining legitimate transactions.

In various embodiments, the contactless card 101 can selectively communicate information depending upon the recipient device. Once tapped, the contactless card 101 can recognize the device to which the tap is directed and based on this recognition the contactless card can provide appropriate data for that device. This advantageously allows the contactless card to transmit only the information required to complete the instant action or transaction, such as a payment or card authentication. By limiting the transmission of data and avoiding the transmission of unnecessary data, both efficiency and data security can be improved. The recognition and selective communication of information can be applied to a various scenarios, including card activation, balance transfers, account access attempts, commercial transactions, and step-up fraud reduction.

If the tap of the contactless card 101 is directed to a device running Apple's iOS® operating system, e.g., an iPhone, iPod, or iPad, the contactless card can recognize the iOS® operating system and transmit data appropriate data to communicate with this device. For example, the contactless card 101 can provide the encrypted identity information necessary to authenticate the card using NDEF tags via, e.g., NFC. Similarly, if the contactless card tap is directed to a device running the Android® operating system, e.g., an Android® smartphone or tablet, the contactless card can recognize the Android® operating system and transmit appropriate and data to communicate with this device (such as the encrypted identity information necessary for authentication by the methods described herein).

As another example, the contactless card tap can be directed to a POS device, including without limitation a kiosk, a checkout register, a payment station, or other terminal. Upon performance of the tap, the contactless card 101 can recognize the POS device and transmit only the information necessary for the action or transaction. For example, upon recognition of a POS device used to complete a commercial transaction, the contactless card 101 can communicate payment information necessary to complete the transaction under the EMV standard.

In various embodiments, the POS devices participating in the transaction can require or specify additional information, e.g., device-specific information, location-specific information, and transaction-specific information, that is to be provided by the contactless card. For example, once the POS device receives a data communication from the contactless card, the POS device can recognize the contactless card and request the additional information necessary to complete an action or transaction.

In various embodiments the POS device can be affiliated with an authorized merchant or other entity familiar with certain contactless cards or accustomed to performing certain contactless card transactions. However, it is understood such an affiliation is not required for the performance of the described methods.

In various embodiments, such as a shopping store, grocery store, convenience store, or the like, the contactless card 101 may be tapped to a mobile device without having to open an application, to indicate a desire or intent to utilize one or more of reward points, loyalty points, coupons, offers, or the like to cover one or more purchases. Thus, an intention behind the purchase is provided.

In various embodiments, the one or more applications may be configured to determine that it was launched via one or more tap gestures of the contactless card 101, such that a launch occurred at 3:51 pm, that a transaction was processed or took place at 3:56 pm, in order to verify identity of the user.

In various embodiments, the one or more applications may be configured to control one or more actions responsive to the one or more tap gestures. For example, the one or more actions may comprise collecting rewards, collecting points, determine the most important purchase, determine the least costly purchase, and/or reconfigure, in real-time, to another action.

In various embodiments, data may be collected on tap behaviors as biometric/gestural authentication. For example, a unique identifier that is cryptographically secure and not susceptible to interception may be transmitted to one or more backend services. The unique identifier may be configured to look up secondary information about individual. The secondary information may comprise personally identifiable information about the user. In various embodiments, the secondary information may be stored within the contactless card.

In various embodiments, the device may comprise an application that splits bills or check for payment amongst a plurality of individuals. For example, each individual may possess a contactless card, and may be customers of the same issuing financial institution, but it is not necessary. Each of these individuals may receive a push notification on their device, via the application, to split the purchase. Rather than accepting only one card tap to indicate payment, other contactless cards may be used. In various embodiments, individuals who have different financial institutions may possess contactless cards 101 to provide information to initiate one or more payment requests from the card-tapping individual.

In various embodiments, the present disclosure refers to a tap of the contactless card. However, it is understood that the present disclosure is not limited to a tap, and that the present disclosure includes other gestures (e.g., a wave or other movement of the card).

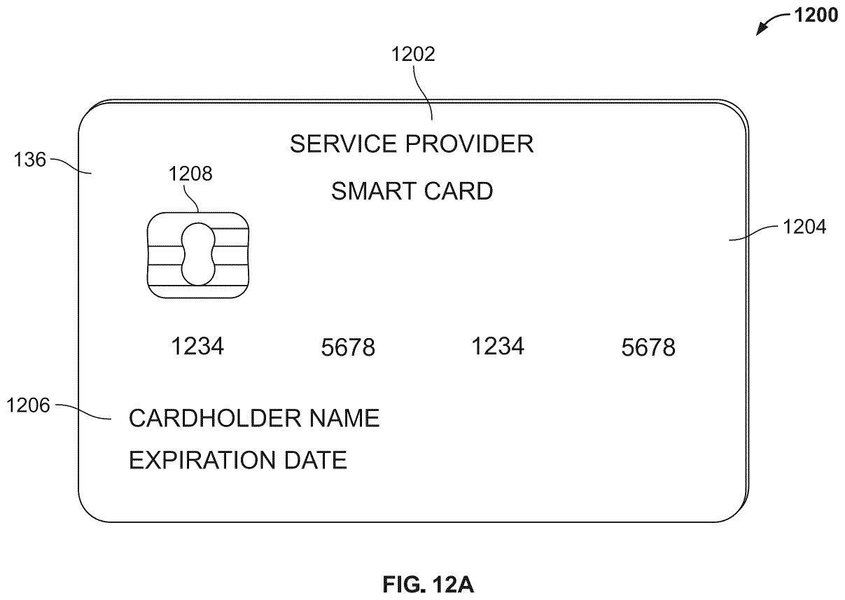

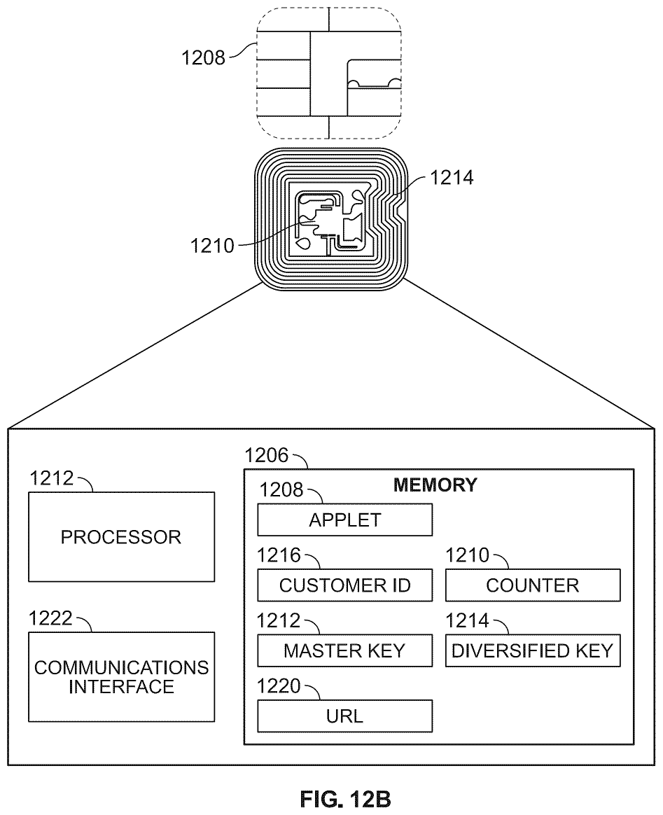

FIG. 12A is a schematic 1200 illustrating an example configuration of a contactless card 101, which may include a payment card, such as a credit card, debit card, or gift card, issued by a service provider as displayed as service provider indicia 1202 on the front or back of the contactless card 101. In some examples, the contactless card 101 is not related to a payment card, and may include, without limitation, an identification card. In some examples, the transaction card may include a dual interface contactless payment card, a rewards card, and so forth. The contactless card 101 may include a substrate 1204, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 101 may have physical characteristics compliant with the ID-1 format of the ISO/IEC 7816 standard, and the transaction card may otherwise be compliant with the ISO/IEC 14443 standard. However, it is understood that the contactless card 101 according to the present disclosure may have different characteristics, and the present disclosure does not require a transaction card to be implemented in a payment card.

The contactless card 101 may also include identification information 1206 displayed on the front and/or back of the card, and a contact pad 1208. The contact pad 1208 may include one or more pads and be configured to establish contact with another client device, such as an ATM, a user device, smartphone, laptop, desktop, or tablet computer via transaction cards. The contact pad may be designed in accordance with one or more standards, such as ISO/IEC 7816 standard, and enable communication in accordance with the EMV protocol. The contactless card 101 may also include processing circuitry, antenna and other components as will be further discussed in FIG. 12B. These components may be located behind the contact pad 1208 or elsewhere on the substrate 1204, e.g., within a different layer of the substrate 1204, and may electrically and physically coupled with the contact pad 708. The contactless card 101 may also include a magnetic strip or tape, which may be located on the back of the card (not shown in FIG. 12A). The contactless card 101 may also include an NFC device coupled with an antenna capable of communicating via the NFC protocol. Embodiments are not limited in this manner.

As illustrated in FIG. 12A, the contact pad 1208 of contactless card 101 may include processing circuitry 1210 for storing, processing, and communicating information, including a processor 1212, a memory 1206, and one or more communications interface 1222. It is understood that the processing circuitry 1210 may contain additional components, including processors, memories, error and parity/CRC checkers, data encoders, anticollision algorithms, controllers, command decoders, security primitives and tamperproofing hardware, as necessary to perform the functions described herein.

The memory 1206 may be a read-only memory, write-once read-multiple memory or read/write memory, e.g., RAM, ROM, and EEPROM, and the contactless card 101 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. A read/write memory may also be read many times after leaving the factory. In some instances, the memory 1206 may be encrypted memory utilizing an encryption algorithm executed by the processor 1212 to encrypted data.

The memory 1206 may be configured to store one or more applets 108, one or more counters 1210, a customer ID 1216, the master key 1212, diversified key 1214, and URLs 1220. The one or more applets 1208 may comprise one or more software applications configured to execute on one or more contactless cards, such as a Java® Card applet. However, it is understood that applet 1208 are not limited to Java Card applets, and instead may be any software application operable on contactless cards or other devices having limited memory. The one or more counter 1210 may comprise a numeric counter sufficient to store an integer. The customer ID 1216 may comprise a unique alphanumeric identifier assigned to a user of the contactless card 101, and the identifier may distinguish the user of the contactless card from other contactless card users. In some examples, the customer ID 1216 may identify both a customer and an account assigned to that customer and may further identify the contactless card 101 associated with the customer's account.

Referring now to FIG. 12B, the processor 1212 and memory elements of the foregoing exemplary embodiments are described with reference to the contact pad 708, but the present disclosure is not limited thereto. It is understood that these elements may be implemented outside of the contact pad 1208 or entirely separate from it, or as further elements in addition to processor 1212 and memory 1206 elements located within the contact pad 1208.

In some examples, the contactless card 101 may comprise one or more antenna(s) 1214. The one or more antenna(s) 1214 may be placed within the contactless card 101 and around the processing circuitry 1210 of the contact pad 1208. For example, the one or more antenna(s) 1214 may be integral with the processing circuitry 1210 and the one or more antenna(s) 1214 may be used with an external booster coil. As another example, the one or more antenna(s) 1214 may be external to the contact pad 1208 and the processing circuitry 1210.

In an embodiment, the coil of contactless card 101 may act as the secondary of an air core transformer. The terminal may communicate with the contactless card 101 by cutting power or amplitude modulation. The contactless card 101 may infer the data transmitted from the terminal using the gaps in the power connection of the contactless card 101, which may be functionally maintained through one or more capacitors. The contactless card 101 may communicate back by switching a load on the coil of the contactless card 101 or load modulation. Load modulation may be detected in the terminal's coil through interference. More generally, using the antenna(s) 1214, processor 1212, and/or the memory 706, the contactless card 101 provides a communications interface to communicate via NFC, Bluetooth, and/or Wi-Fi communications.

As explained above, contactless card 101 may be built on a software platform operable on smart cards or other devices having limited memory, such as JavaCard, and one or more or more applications or applets may be securely executed. Applet 1208 may be added to contactless cards to provide a passcode for multifactor authentication (MFA) in various mobile application-based use cases. Applet 1208 may be configured to respond to one or more requests, such as near field data exchange requests, from a reader, such as a mobile NFC reader (e.g., of a mobile device 110 or point-of-sale terminal), and produce an NDEF message that comprises a cryptographically secure passcode encoded as an NDEF text tag. The NDEF message may include the URL 1220, the cryptogram 134, and any other data.

One example of an NDEF passcode is an NDEF short-record layout (SR=1). In such an example, one or more applets 1208 may be configured to encode the passcode as an NDEF type 4 well known type text tag. In some examples, NDEF messages may comprise one or more records. The applet 1208 may be configured to add one or more static tag records in addition to the passcode record.

In some examples, the one or more applets 1208 may be configured to emulate an RFID tag. The RFID tag may include one or more polymorphic tags. In some examples, each time the tag is read, different cryptographic data is presented that may indicate the authenticity of the contactless card. Based on the one or more applets 1208, an NFC read of the tag may be processed, the data may be transmitted to a server, such as a server of the institution, e.g., a banking system, and the data may be validated at the server.

In some examples, the contactless card 101 and server may include certain data such that the card may be properly identified. The contactless card 101 may include one or more unique identifiers (not pictured). Each time a read operation takes place, the counter 1210 may be configured to increment. In some examples, each time data from the contactless card 101 is read (e.g., by a mobile device), the counter 1210 is transmitted to the server for validation and determines whether the counter 1210 are equal (as part of the validation) to a counter of the server.

The one or more counter 1210 may be configured to prevent a replay attack. For example, if a cryptogram has been obtained and replayed, that cryptogram is immediately rejected if the counter 1210 has been read or used or otherwise passed over. If the counter 1210 has not been used, it may be replayed. In some examples, the counter that is incremented on the contactless card 101 is different from the counter that is incremented for transactions. The contactless card 101 is unable to determine the application transaction counter 1210 since there is no communication between applets 108 on the contactless card 101. In some examples, the contactless card 101 may comprise a first applet, which may be a transaction applet, and a second applet, where each applet may comprise a respective counter 1210.

In some examples, the counter 1210 may get out of sync. In some examples, to account for accidental reads that initiate transactions, such as reading at an angle, the counter 1210 may increment but the application does not process the counter 1210. In some examples, when the mobile device 110 is woken up, NFC may be enabled and the device 102 may be configured to read available tags, but no action is taken responsive to the reads.

To keep the counter 1210 in sync, an application, such as a background application, may be executed that would be configured to detect when the mobile device 110 wakes up and synchronize with the server of a banking system indicating that a read that occurred due to detection to then move the counter 1210 forward. In other examples, Hashed One Time Password may be utilized such that a window of mis-synchronization may be accepted. For example, if within a threshold of 10, the counter 1210 may be configured to move forward. But if within a different threshold number, for example within 10 or 1000, a request for performing re-synchronization may be processed which requests via one or more applications that the user tap, gesture, or otherwise indicate one or more times via the user's device. If the counter 1210 increases in the appropriate sequence, then it possible to know that the user has done so.

The key diversification technique described herein with reference to the counter 1210, master key, and diversified key, is one example of encryption and/or decryption a key diversification technique. This example key diversification technique should not be considered limiting of the disclosure, as the disclosure is equally applicable to other types of key diversification techniques.

During the creation process of the contactless card 101, two cryptographic keys may be assigned uniquely per card. The cryptographic keys may comprise symmetric keys which may be used in both encryption and decryption of data. Triple DES (3DES) algorithm may be used by EMV and it is implemented by hardware in the contactless card 101. By using the key diversification process, one or more keys may be derived from a master key based upon uniquely identifiable information for each entity that requires a key.

In some examples, to overcome deficiencies of 3DES algorithms, which may be susceptible to vulnerabilities, a session key may be derived (such as a unique key per session) but rather than using the master key, the unique card-derived keys and the counter may be used as diversification data. For example, each time the contactless card 101 is used in operation, a different key may be used for creating the message authentication code (MAC) and for performing the encryption. This results in a triple layer of cryptography. The session keys may be generated by the one or more applets and derived by using the application transaction counter with one or more algorithms (as defined in EMV 4.3 Book 2 A1.3.1 Common Session Key Derivation).

Further, the increment for each card may be unique, and assigned either by personalization, or algorithmically assigned by some identifying information. For example, odd numbered cards may increment by 2 and even numbered cards may increment by 5. In some examples, the increment may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In another example, the NDEF record may be encoded in hexadecimal format.

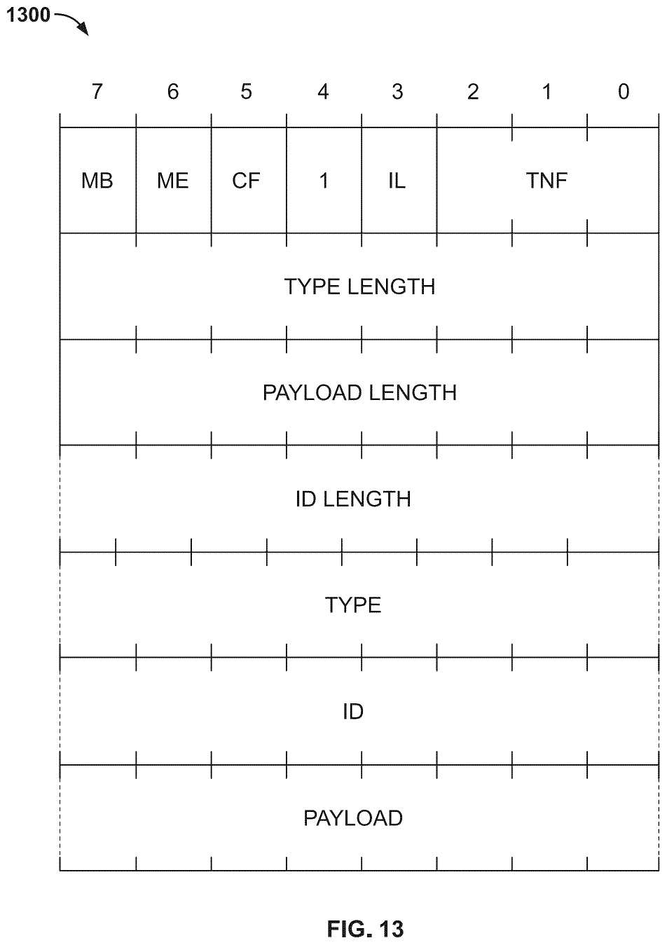

FIG. 13 illustrates an NDEF short-record layout (SR=1) data structure 1300 according to an example embodiment. One or more applets may be configured to encode the passcode as an NDEF type 4 well known type text tag. In some examples, NDEF messages may comprise one or more records. The applets may be configured to add one or more static tag records in addition to the passcode record. Exemplary tags include, without limitation, Tag type: well-known type, text, encoding English (en); Applet ID: D2760000850101; Capabilities: read-only access; Encoding: the authentication message may be encoded as ASCII hex; type-length-value (TLV) data may be provided as a personalization parameter that may be used to generate the NDEF message. In an embodiment, the authentication template may comprise the first record, with a well-known index for providing the actual dynamic authentication data. The data structure 1300 may include the URL 1220, the cryptogram 15324, and any other data provided by the applet 1208.

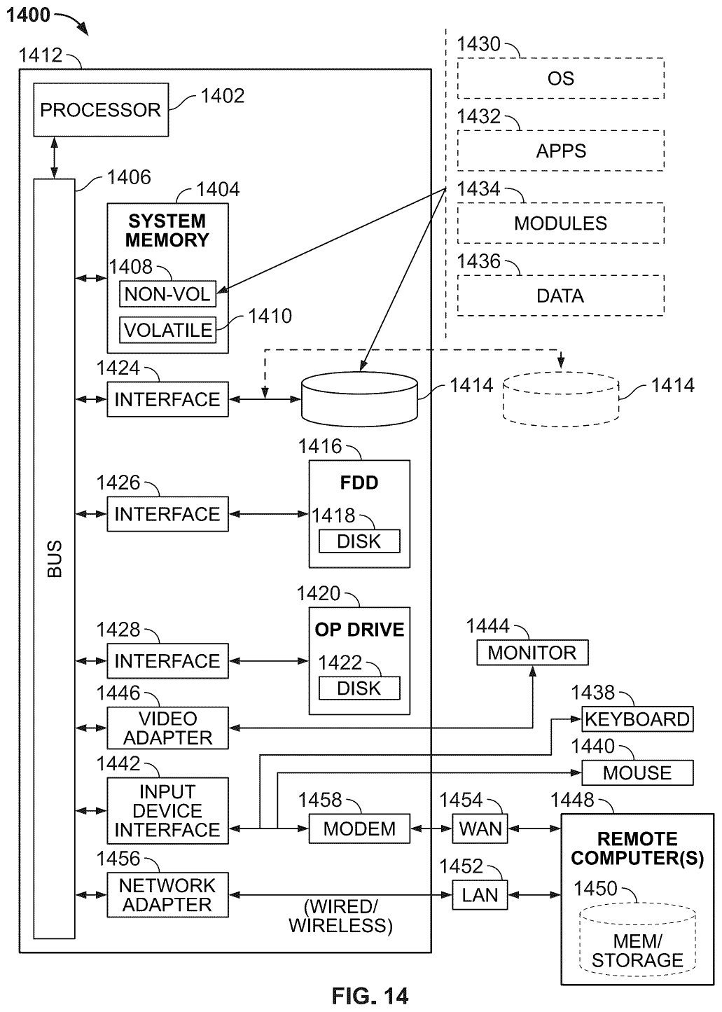

FIG. 14 illustrates an embodiment of an exemplary computer architecture 1400 suitable for implementing various embodiments as previously described. In one embodiment, the computer architecture 1400 may include or be implemented as part of computing system 100.

As used in this application, the terms “system” and “component” are intended to refer to a computer-related entity, either hardware, a combination of hardware and software, software, or software in execution, examples of which are provided by the exemplary computing computer architecture 1400. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computer architecture 1400 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 100.

As shown in FIG. 14, the computer architecture 1400 includes a processor 902, a system memory 1404 and a system bus 1406. The processor 1402 can be any of various commercially available processors.

The system bus 1406 provides an interface for system components including, but not limited to, the system memory 1404 to the processor 1402. The system bus 1406 can be any of several types of bus structure that may further interconnect to a memory bus (with or without a memory controller), a peripheral bus, and a local bus using any of a variety of commercially available bus architectures. Interface adapters may connect to the system bus 1406 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computer architecture 1400 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 1404 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 14, the system memory 1404 can include non-volatile 1408 and/or volatile 1410. A basic input/output system (BIOS) can be stored in the non-volatile 1408.

The computer 1412 may include various types of computer-readable storage media in the form of one or more lower speed memory units, including an internal (or external) hard disk drive 1414, a magnetic disk drive 1416 to read from or write to a removable magnetic disk 1418, and an optical disk drive 1420 to read from or write to a removable optical disk 1422 (e.g., a CD-ROM or DVD). The hard disk drive 1414, magnetic disk drive 1416 and optical disk drive 1420 can be connected to system bus 1406 the by an HDD interface 1424, and FDD interface 1426 and an optical disk drive interface 1428, respectively. The HDD interface 1424 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and non-volatile 1408, and volatile 1410, including an operating system 1430, one or more applications 1432, other program modules 1434, and program data 1436. In one embodiment, the one or more applications 1432, other program modules 1434, and program data 1436 can include, for example, the various applications and/or components of the system 100A.

A user can enter commands and information into the computer 1412 through one or more wire/wireless input devices, for example, a keyboard 1438 and a pointing device, such as a mouse 1440. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processor 1402 through an input device interface 1442 that is coupled to the system bus 1406 but can be connected by other interfaces such as a parallel port, IEEE 1394 serial port, a game port, a USB port, an IR interface, and so forth.

A monitor 1444 or other type of display device is also connected to the system bus 906 via an interface, such as a video adapter 1446. The monitor 1444 may be internal or external to the computer 1412. In addition to the monitor 1444, a computer typically includes other peripheral output devices, such as speakers, printers, and so forth.

The computer 1412 may operate in a networked environment using logical connections via wire and/or wireless communications to one or more remote computers, such as a remote computer(s) 1448. The remote computer(s) 1448 can be a workstation, a server computer, a router, a personal computer, portable computer, microprocessor-based entertainment appliance, a peer device or other common network node, and typically includes many or all the elements described relative to the computer 1412, although, for purposes of brevity, only a memory and/or storage device 1450 is illustrated. The logical connections depicted include wire/wireless connectivity to a local area network 1452 and/or larger networks, for example, a wide area network 1454. Such LAN and WAN networking environments are commonplace in offices and companies, and facilitate enterprise-wide computer networks, such as intranets, all of which may connect to a global communications network, for example, the Internet.

When used in a local area network 1452 networking environment, the computer 1412 is connected to the local area network 1452 through a wire and/or wireless communication network interface or network adapter 1456. The network adapter 1456 can facilitate wire and/or wireless communications to the local area network 1452, which may also include a wireless access point disposed thereon for communicating with the wireless functionality of the network adapter 1456.

When used in a wide area network 1454 networking environment, the computer 1412 can include a modem 1458, or is connected to a communications server on the wide area network 1454 or has other means for establishing communications over the wide area network 1454, such as by way of the Internet. The modem 1458, which can be internal or external and a wire and/or wireless device, connects to the system bus 1406 via the input device interface 1442. In a networked environment, program modules depicted relative to the computer 1412, or portions thereof, can be stored in the remote memory and/or storage device 1450. It will be appreciated that the network connections shown are exemplary and other means of establishing a communications link between the computers can be used.

The computer 1412 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11 (a, b, g, n, etc.) to provide secure, reliable, fast wireless connectivity. A Wi-Fi network can be used to connect computers to each other, to the Internet, and to wire networks (which use IEEE 802.3-related media and functions).

One embodiment provides a method of card-based authentication. The method includes receiving, by a server, a request associated with a contactless card. The request indicates a request type and a card number. The card number is read from the contactless card when the contactless card is within a communication range of a device. The card number is read by an application configured to execute on the device. The operation includes determining that the request type specifies to authenticate a user of the device. The operation includes retrieving an indicator characterizing an identity of the user. The indicator is retrieved based on identifying a match for the card number in a data source. The indicator is associated with the card number in the data source. The user is authenticated based on the indicator to obtain an authentication result. No payment transaction for the user is processed responsive to the request.

In some embodiments, the server is configured to, upon determining that the request type specifies to process a payment transaction for the user, perform a predefined operation to handle the payment transaction. No indicator of the identity of the user is returned responsive to the request. The predefined operation includes processing the payment transaction or forwarding the payment transaction for processing.

In one embodiment, the server is of at least one of an acquiring entity or a card network, and the method further includes returning at least one of the indicator or the authentication result to the application. In some embodiments, the request type is indicated via a flag, and the request further indicates a zero-amount authorization of payment. In one embodiment, authenticating the user based on the indicator validates the contactless card as being a possession factor in a multi-factor authentication process that includes a knowledge factor or an inheritance factor.

In some embodiments, the device is a first device, and the request further indicates a device identifier of the device. The method further includes determining that a binding exists between the device and the contactless card. The determination is made based on identifying an association between the card number and the device identifier in the data source. The indicator is only returned to the application upon determining that the contactless card is not only bound to one or more devices other than the device.

Another embodiment provides a non-transitory computer-readable medium containing a program of a server. The program executable to perform an operation for card-based authentication. The operation includes receiving a request associated with a contactless card, the request indicating a request type and a card number. The card number is read from the contactless card when the contactless card is within a communication range of a device. The card number is read by an application configured to execute on the device. The operation includes determining that the request type specifies to authenticate a user of the device. The operation includes retrieving an indicator characterizing an identity of the user. The indicator is retrieved based on identifying a match for the card number in a data source. The indicator is associated with the card number in the data source. The user is authenticated based on the indicator to obtain an authentication result. No payment transaction for the user is processed responsive to the request.

Still another embodiment provides a system of card-based authentication. The system includes one or more computer processors and a memory containing a program. The program is executable by the one or more computer processors to perform an operation. The operation includes receiving a request associated with a contactless card, the request indicating a request type and a card number. The card number is read from the contactless card when the contactless card is within a communication range of a device. The card number is read by an application configured to execute on the device. The operation also includes determining that the request type specifies to authenticate a user of the device. The operation also includes retrieving an indicator characterizing an identity of the user. The indicator is retrieved based on identifying a match for the card number in a data source. The indicator is associated with the card number in the data source. The user is authenticated based on the indicator to obtain an authentication result. No payment transaction for the user is processed responsive to the request.

The various elements of the devices as previously described with reference to FIG. 15 to FIG. 9 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

FIG. 15 depicts a schematic of an exemplary system 100, consistent with disclosed embodiments. As shown, the system 100 includes one or more contactless cards 101, one or more mobile devices 110, and a server 120. The contactless cards 101 are representative of any type of payment card, such as a credit card, debit card, ATM card, gift card, and the like. In various embodiments, the contactless card 101 or card 101 is a virtual payment card. The contactless card 101 may comprise one or more chips (not depicted), such as a radio frequency identification (RFID) chip, configured to communicate with the mobile devices 110 via NFC, the EMV standard, or other short-range protocols in wireless communication. Although NFC is used as an example communications protocol, the disclosure is equally applicable to other types of wireless communications, such as other suitable communication protocols pursuant to the EMV standard, Bluetooth, and/or Wi-Fi. The mobile devices 110 are representative of any type of network-enabled computing devices, such as smartphones, tablet computers, wearable devices, laptops, portable gaming devices, personal computers, and the like. The server 120 is representative of any type of computing device, such as a server, workstation, computer cluster, cloud computing platform, virtualized computing system, and the like.

As shown, a memory 102 of the contactless card includes card data 1503, a counter 1504, a card master key 1505, a diversified key 1506, a unique customer identifier 1507, and a data store of account numbers 1508. In some instances, the contactless cards 101 may include two or more unique card master keys 1505, which may be utilized to generate two or more diversified keys 1506, as discussed herein.

The card data 1503 generally includes account-related information, such as information used to process a payment using the contactless card 101. For example, card data 1503 may comprise an account number, an expiration date, a billing address, and a card verification value (CVV). The account number may be any type of account number, such as a primary account number (PAN), a virtual account number, and/or a token generated based on the PAN. Other types of account numbers are contemplated, and the use of the account number or other types of card data 1503 should not be considered limiting of the disclosure. The card data 1503 may further include names, billing address, shipping address, and other account-related information. The account numbers 1508 store one-time-use virtual account numbers with associated expiration dates and CVV values. For example, the account numbers 1508 may include thousands single-use virtual account numbers, expiration dates, and CVV values.

As shown, a memory 151511 of the mobile device 1510 includes an instance of an operating system (OS) 1512 and a processor 1518 may execute one or more operations associated with the applications of the operating system (OS) 1512 and/or perform any other suitable operation associated with processor activity, including comparison operations and executing instructions associated with memory 151511. Example operating systems 1512 include the Android® OS, iOS®, Linux®, and Windows® operating systems. As shown, the OS 1512 includes one or more applications, including an account application 1513, an authentication service 1514 (hereinafter referred to as “authentication application” for convenience), one or more other applications 1515, and/or one or more access applications 1516. The account application 1513 allows users to perform various account-related operations, such as viewing account balances, purchasing items, and processing payments. Initially, a user may authenticate using authentication credentials to access the account application 1513. For example, the authentication credentials may include a username and password, biometric credentials, and the like.

The authentication service 1514 is generally configured to determine when a contactless card and/or a user associated with a contactless card requires authentication for a transaction, service, event or accessibility request, including for purposes distinct from a payment event, wireless communication, service, or request. In some instances, the authentication service 1514 may determine and/or process an authentication request to authenticate a user to perform any function, e.g., access another application on a device, access a space, authenticate themselves on a call, perform auto-fill functions, or any other type of tap-to functions. In some instances, the authentication service 1514 may be implemented as a function or portion of the executable code of another application and may be utilized by that application to perform authentication operations. For example, the authentication service 1514 may be implemented in another application like a banking application. In other instances, the authentication service 1514 may be a standalone application that is called to perform authentication operations, as discussed herein.

In some instances, the authentication service 1514 may determine that a user requires access to a particular application that is distinct from a payment request, such as access application 1516. In various embodiments, the access application 1516 can be associated with a contactless card associated with the user. Access application 1516 may be or may include an application configured to grant access to a particular service associated with a user account, such as a transportation service (e.g. public transit), health insurance account, a financial account or financial application that contains account balances, brokerage information, or any other suitable financial data, a service application (retail services, delivery services, entertainment services, gaming services, etc.), and any other suitable application that may require user and/or contactless card authentication.

In various embodiments, access application 1516 is associated with a first-level user account options of a user account, where the first-level user account options may include a display of an account balance, a display of recent transactions, and/or the like. In various embodiments, the access application 1516 may be associated with a payment feature, e.g. a credit or bank account for making or receiving payment, but the authentication communication may still implicate a non-payment feature for authentication or verification, e.g. credit or debit card activation. In various embodiments, the authentication service 1514 may facilitate the authentication protocol utilizing a separate API interface and call for access to access applications 1516. The authentication service 1514 may be configured to verify a contactless card and/or user associated with a contactless card by utilizing any suitable payment protocol, including one or more of any verification process utilizing cryptographic techniques, e.g. a standard or authentication protocol compliant with an EMV standard. In various embodiments, the authentication service 1514 is configured to synchronize a counter 1504 associated with a contactless card 101 and a server 120 associated with an issuer, e.g. authentication server of an issuer, that can communicate with the contactless card 101 and the mobile device when an authentication of the contactless card 101 and/or a user associated with the contactless card 101 takes place.

In various embodiments, the authentication service 1514 may coordinate with the server 120 and/or the contactless card 101 to log an authorization for a non-payment communication (e.g. communication) in relation to the counter. The log may be a counter log 121 located in a memory 122 of the server 120 or a memory 102 of the contactless card 101. The log may keep a separate tally of events that are payment events and/or communications and non-payment events and/or communications, irrespective of the total tally of the counter 1504, and the server 120 or the contactless card 101. The server 120 and/or the authentication service 1514 communicating with the contactless card may utilize the information contained therein for an anti-fraud measure. For example, the authentication service 1514 and/or the server 120 may decline a payment event and/or communication if a threshold number of non-payment events and/or communications is too small (or too large) in between the non-payment events and/or communications and the payment events and/or communication or vice versa. In various embodiments, the counter log 121 containing distinguishing information, e.g. counts, between non-payment and payment communications and/or transactions may be used for any other suitable purposes during a verification protocol.

In various embodiments, the authentication service 1514 is associated with the account application 1513. For example, the authentication service 1514 may be installed on the mobile device 1510 with the account application 1513, and the user is prompted to enable the authentication service 1514 subsequent to the installation. More generally, each time the account application 1513 is opened, the account application 1513 may determine whether the authentication service 1514 is enabled as the default authentication application for the OS 1512. If the authentication service 1514 is not enabled as the default authentication application, the account application 1513 may prompt the user to enable the authentication service 1514 as the default authentication application for the OS 1512 and/or to enable one or more functionalities of the authentication service 1514. Once enabled as the default authentication application for the OS 1512, the authentication service 1514 may programmatically identify when authorization applications require authentication and may utilize a payment protocol to enable the verification, even if a payment is not associated with the verification or authorization. In various embodiments, in order to initiate an authentication or verification protocol, the authentication service 1514 may prompt the user to tap a contactless card 101 to the mobile device 1510 to initiate the authentication service 1514 or one or more operations associated therewith.

Generally, in various embodiment described herein, a verification or authentication protocol may include one or more of the following operations: the authentication application may initiate a communication, e.g. wireless communication, to verify a contactless card and/or an identity of a user associated with the contactless card, where the authentication application may initiate the application in whole or in part, e.g. access application 1516, by prompting the user to tap a contactless card 101 on a computer device, e.g. mobile device 1510. The communication may involve an NFC communication between a card reader 1534 and a contactless card 101, where the contactless card 101 may provide the mobile device 1510 with one or more inputs, including encrypted data, and a latest version of an application transaction counter (ATC), and the contactless card 101 or the mobile device 1510 (including any suitable components associated therewith) may generate a suitable cryptogram based on the plurality of inputs, and then the contactless card 101 or the mobile device 1510 (including any suitable components associated therewith) may transmit the cryptogram and the ATC to an issuer of the contactless card 101 (e.g. a server 120 associated with the issuer).

The contactless card 101 and/or the user may then be verified and receive access to one or more features associated with application 1516 by receiving a response from the issuer, e.g. authentication server of the issuer, verifying or authorizing the contactless card (and by extension the user associated therewith), where the received response is based at least one cryptographic operations performed by the issuer (e.g. server 120) in response to receiving the cryptogram, and where the generation of the cryptogram and the received response from the issuer, e.g. authentication server of the issuer, is based on a payment protocol, and where the communication and verification of the contactless card and/or user identity of the user is distinct from completing a payment in relation to the payment protocol. As described herein, the protocol may be initiated by one or more taps of the contactless card 101 on the mobile device 1510.

In various embodiments, where the contactless card 101 is a virtual payment card, the authentication service 1514 may retrieve information associated with the contactless card 101 by accessing a digital wallet implemented on the mobile device 1510, where the digital wallet includes the virtual payment card.

As shown, the server 120 further includes a data store of account data 1524 and a memory 1520. The account data 1524 includes account-related data for a plurality of users and/or accounts. The account data 1524 may include at least a master key 1526, counter 1528, such as an application transaction counter (“ATC”) 1528 a customer ID 1530, an associated contactless card 101, account holder name, account billing address, one or more shipping addresses, one or more virtual card numbers, and biographical information for each account. The memory 1520 includes a management application 1532 and instances of the card data 1503, the counter 1528, master key 1526, and diversified key (not shown) for one or more accounts from the account data 1524. The system 100 is configured to implement key diversification to secure data, which may be referred to as a key diversification technique herein.

In various embodiments, the authentication service 1514 receives, from a user, a first application user credential associated with a user profile. The first application user credential may include biometrics data, an established gesture associated with user recognition, a username and password combination, and/or the like. The processor 1518 compares the first application user credential with a stored second application user credential. The stored second application user credential may be associated with the user identity and it may be stored either in the memory 151511 of mobile device 1510 or in the memory 1520 of the server 120. In various embodiments, the stored second application user credential is maintained on the server 120 and the first match is performed by the server 120. In various embodiments, upon determining a first match between the first application user credential and the stored second application user credential, the authentication application may grant the user access to one or more first-level user account options of a user account. The user account may be a financial account, a health insurance account, and/or any other account of the like associated with any service provider (e.g., a transit account, an entertainment account, etc.). Once the first match is determined, the user may access certain first-level user account options. The first-level user account options of a user account may include a display of an account balance, a display of recent transactions, events and/or the like. For greater access and/or executing certain account functions, i.e., second-level user account options, second-factor authentication may be required. The second-level user account options may include a personal identification number (PIN) change request, and an address change request. Various embodiments associated with first-level and/or second-level access are discussed in greater detail below.

In various embodiments, the first match between the first application user credential and the stored second application user credential serves as a precondition for initiating and completing a verification, and the first-level access and/or the second-level access to one or more features of access application 1516 is not granted until completion of the verification protocol. In various embodiments, the first match between the first application user credential and the stored second application user credential serves as a precondition for commencing the protocol, but access to first-level information is granted responsive the first match, and where the second-level user access requires, in addition to any other precondition, e.g. a second comparison associated with user information as discussed below, completion of the protocol to grant access to the second-level information.

Generally, the server 120 (or another computing device) and the contactless card 101 may be provisioned with the same master key 1526 (also referred to as a master symmetric key or card master key). More specifically, each contactless card 101 is programmed with a distinct master key 1526 that has a corresponding pair in the server 120. For example, when a contactless card 101 is manufactured, a unique master key 1526 may be programmed into the memory 102 of the contactless card 101. Similarly, the unique master key 1526 may be stored in a record of a customer associated with the contactless card 101 in the account data 1524 of the server 120 (and/or stored in a different secure location). The master key may be kept secret from all parties other than the contactless card 101 and server 120, thereby enhancing security of the system 100.

The master keys 1526 may be used in conjunction with the counters 1504 to enhance security using key diversification. The counters 1504 comprise values that are synchronized between the contactless card 101 and server 120. The counter value 1504 may comprise a number that changes each time data is exchanged between the contactless card 101 and the server 120 (and/or the contactless card 101 and the mobile device 1510). To enable NFC data transfer between the contactless card 101 and the mobile device 1510, the account application 1513 may communicate with the contactless card 101 when the contactless card 101 is sufficiently close to a card reader 1534 (e.g. within NFC range) of the mobile device 1510. Card reader 1534 may be a digital reader with NFC capabilities, e.g. an NFC reader, and may be configured to read from and/or communicate with contactless card 101 (e.g., via NFC, Bluetooth, RFID, etc.). Therefore, example card readers 1534 include NFC communication modules, Bluetooth communication modules, and/or RFID communication modules.

For example, a contactless card and/or a user associated with the contactless card may require authorization or verification to access an access application 1516. One or more components of the system 100, including authentication service 1514 may initiate a communication (e.g. API call or another suitable mechanism) with the access application 1516 to utilize one or more payment protocols to verify or authenticate the contactless card, and/or in various embodiments, a user associated therewith, even if the access application 1516, or a particular aspect sought for access by the user of the access application 1516, does not involve making a payment.

In various embodiments, the authentication service 1514 may provide a user with a prompt so that the user may tap the contactless card 101 to the mobile device 1510, thereby bringing the contactless card 101 sufficiently close to the card reader 1534 of the mobile device 1510 to enable NFC data transfer between the contactless card 101 and the card reader 1534 of the mobile device 1510. In various embodiments, the mobile device 1510 may trigger the card reader 1534 via an API call. In addition, and/or alternatively, the mobile device 1510 may trigger the card reader 1534 based on periodically polling the card reader 1534. More generally, the mobile device 1510 may trigger the card reader 1534 to engage in communications using any feasible method.

In various embodiments, prior to initiating any communication in relation to the contactless card 101, the card reader 1534, and the mobile device 1510, and/or immediately after establishing a communication between the contactless card 101 and the card reader 1534, the authentication service 1514 may receive a first application user credential as a precondition for card activation and/or for commencing with the authentication protocol. A user may provide the first application user credentials after receiving a prompt from the authentication application to enter the credentials. As noted above, the first application user credentials may include biometrics data, an established gesture associated with user recognition, a username and password combination, facial recognition, and/or the like. As noted above, in various embodiments, the authentication service 1514 communicates the first application user credentials to the processor 1518. The processor 1518 compares the first application user credentials with stored second application user credential. The stored second application user credential may be located within a memory 151511 associated with the mobile device 1510, the memory 102 associated with contactless card 101, and/or a memory 1520 associated with the server 120. In various embodiments, the first application user credential is provided to the server 120, and the server 120 compares the first application user credential to the stored second application user credential. In various embodiments, as noted above, the processor 1518 communicates the comparison result to the authentication service 1514 (e.g., for a match).

In various embodiments, a first match may initiate or serve as precondition for one or more of i) initiating the rest of the verification protocol for verifying or authenticating the user to access the access application 1516 and/or ii) grants the user access to first-level user account options of a user account associated with access application 1516 (e.g., display of an account balance and/or recent transactions and/or recent communications). As such, in various embodiments, responsive to finding a first match the verification authentication application initiates additional operations to verify the user identity, including but not limited to authenticating a contactless card associated with the user.

In various embodiments, a second-level verification may be initiated as a further condition for commencing or initiating additional operations. For example, the processor 1518 compares at least a portion of the user identity with at least a portion of the cardholder identification information. In various embodiments, a second match grants the user access to second-level user account options of a user account (e.g. a card activation, a personal identification number (PIN) change request, and an address change request). According to various embodiments, the second-level user account options represent more secured features associated with access application 1516.

In various embodiments, the first match of the first application user credential to the stored second application user credential may or may not grant first-level access to an application, e.g. access application 1516, but the first match serves may, in any event, serve as a precondition for initiating the protocol. In various embodiments where the first-level access was not granted initially, successful completion of the protocol results in granting first-level access. In various embodiments, the second-level access to access application 1516 is granted immediately upon completion of the verification protocol. In various embodiments, where the first-level access was granted only after completion of the protocol, including embodiments where the first match was used or omitted, the second-level access is granted only upon a second verification protocol being successfully completed, where in various embodiments, the second verification protocol is initiated only after a suitable component successfully completes a second match, e.g. compares at least a portion of the user identity with at least a portion of the cardholder identification information. In various embodiments, the successful completion of the second match, by itself, grants access to the second level feature of access application 1516 and serves as a precondition to completing the second protocol (the one not associated with the first-level access), and successful completion of the second protocol grants access to additional features of access application 1516.

In various embodiments, whether a first-level and/or second-level and/or additional precondition is applied or takes place, after communication has been established between mobile device 1510 and contactless card 101, the contactless card 101 generates a message authentication code (MAC) cryptogram. In various embodiments, this may occur when the contactless card 101 is read by the account application 1513. In particular, this may occur upon a read, such as an NFC read, of a near field data exchange (NDEF) tag, which may be created in accordance with the NFC Data Exchange Format. For example, a reader, such as the account application 1513 and/or the card reader 1534, may transmit a message, such as an applet select message, with the applet ID of an NDEF producing applet. In various embodiments, the generated cryptogram may be an authorization request cryptogram (ARQC) consistent with an EMV standard.

In various embodiments, upon confirmation of the selection, a sequence of select file messages followed by read file messages may be transmitted. For example, the sequence may include “Select Capabilities file”, “Read Capabilities file”, and “Select NDEF file”. At this point, the counter value 1504 maintained by the contactless card 101 may be updated or incremented, which may be followed by “Read NDEF file.” At this point, the message may be generated which may include a header and a shared secret. Session keys may then be generated. The MAC cryptogram may be created from the message, which may include the header and the shared secret. The MAC cryptogram may then be concatenated with one or more blocks of random data, and the MAC cryptogram and a random number (RND) may be encrypted with the session key. Thereafter, the cryptogram and the header may be concatenated, and encoded as ASCII hex and returned in NDEF message format (responsive to the “Read NDEF file” message). In various embodiments, the MAC cryptogram may be transmitted as an NDEF tag, and in other examples the MAC cryptogram may be included with a uniform resource indicator (e.g., as a formatted string). The contactless card 101 may then transmit the MAC cryptogram to the mobile device 1510, which may then forward the MAC cryptogram to the server 120 for verification as explained below.

More generally, when preparing to send data (e.g., to the server 120 and/or the mobile device 1510), the contactless card 101 may increment the counter value 1504. The contactless card 101 may then provide the master key 1526 and counter value 1504 as input to a cryptographic algorithm, which produces a diversified key 1506 as output. The cryptographic algorithm may include encryption algorithms, hash-based message authentication code (HMAC) algorithms, cipher-based message authentication code (CMAC) algorithms, and the like. Non-limiting examples of the cryptographic algorithm may include a symmetric encryption algorithm such as 3DES or AES128; a symmetric HMAC algorithm, such as HMAC-SHA-256; a symmetric CMAC algorithm such as AES-CMAC; and/or any other algorithm or technique consistent with any applicable version of ISO/IEC 1833 and/or ISO/IEC 7816. The contactless card 101 may then encrypt the data (e.g., the customer identifier 1507 and any other data) using the diversified key 1506. The contactless card 101 may then transmit the encrypted data (e.g., cryptogram 134, which can be an encrypted customer ID) to the account application 1513 of the mobile device 1510 (e.g., via an NFC connection, Bluetooth connection, etc.). The account application 1513 of the mobile device 1510 may then transmit the encrypted data to the server 120 via the network 130. In at least various embodiments, the contactless card 101 transmits the counter value 1504 with the encrypted data. In such embodiments, the contactless card 101 may transmit an encrypted counter value 1504, or an unencrypted counter value 1504.

Upon receiving the cryptogram 134, the management application 1532 of the server 120 may perform the same symmetric encryption using the counter value 1504 as input to the encryption, and the master key 1526 as the key for the encryption. As stated, the counter value 1504 may be specified in the data received from the mobile device 1510, or a counter value 1504 maintained by the server 120 to implement key diversification for the contactless card 101. The output of the encryption may be the same diversified key value 1506 that was created by the contactless card 101. The management application 1532 may then decrypt the cryptogram 134 received via the network 130 using the diversified key 1506, which reveals the data transmitted by the contactless card 101 (e.g., at least the customer identifier 1507). Doing so allows the management application 1532 to verify the data transmitted by the contactless card 101 via the mobile device 1510, e.g., by comparing the decrypted customer ID 1507 to a customer ID in the account data 1524 for the account.

Although the counter 1504, e.g. ATC, is used as an example, other data may be used to secure communications between the contactless card 101, the mobile device 1510, and/or the server 120. For example, the counter 1504 may be replaced with a random nonce, generated each time a new diversified key 1506 is needed, the full value of a counter value sent from the contactless card 101 and the server 120, a portion of a counter value sent from the contactless card 101 and the server 120, a counter independently maintained by the contactless card 101 and the server 120 but not sent between the two, a one-time-passcode exchanged between the contactless card 101 and the server 120, and a cryptographic hash of data. In various embodiments, one or more portions of the diversified key 1506 may be used by the parties to create multiple diversified keys 1506.

As shown, the server 120 may include one or more hardware security modules (HSM) 125. For example, one or more HSMs 125 may be configured to perform one or more cryptographic operations as disclosed herein. In various embodiments, one or more HSMs 125 may be configured as special purpose security devices that are configured to perform the one or more cryptographic operations. The HSMs 125 may be configured such that keys are never revealed outside the HSM 125, and instead are maintained within the HSM 125. For example, one or more HSMs 125 may be configured to perform at least one of key derivations, decryption, and MAC operations. The one or more HSMs 125 may be contained within, or may be in data communication with, server 120.

As stated, the key diversification technique may be used to perform secure operations using the contactless card 101. For example, once the management application 1532 verifies the cryptogram 134 using key diversification, the management application 1532 may transmit a message to the authentication service 1514 indicating that the contactless card 101 and/or the user associated therewith is verified and/or authenticated, and the authentication service 1514 can grant the user access to the authentication application 1516 as a result. In various embodiments, the output transmitted may include an authorization response cryptogram (ARPC).

As is inherent in one or more embodiments described herein, including the above discussion, the server 120 that may be used in authentication or verification may be configured to operate consistent with an EMV standard, including performing operations that utilize an EMV payment protocol for non-payment purposes. The host server (or system) 120 may be associated with an issuer, e.g. authentication server of the issuer, of a card associated with a user, and the host system including a non-transitory computer-readable storage medium storing computer-readable program code executable by a processor, where the processor and storage medium may contain one or more hardware or software components, including those generally described in FIG. 8. The host system may be configured to receive a transaction or communication data associated with an access application 1516 and/or a contactless card 101. The receipt of the transaction or communication data may be facilitated as described herein, e.g. by a authentication service 1514 (or other suitable component or application of mobile device 1510) associated with a mobile device 1510 and the user (or other suitable computer device), where the authentication service 1514 may initiate an authentication or verification communication with one or more other components, e.g. a contactless card 101 and a card reader 1534. The transaction or communication data received by the server 120 from the authentication service 1514. The transaction or communication data may include i) a counter (e.g. ATC) and a cryptogram based on one or more inputs of the communication and a symmetric key associated with the card. In various embodiments, the cryptogram is an authorization request cryptogram (ARQC).

In various embodiments, the server 120 may have a separate log, e.g. counter log 121, for logging the ATC value as being associated with a non-payment event or communication, where the one or more inputs provided by the mobile device 1510 may include a designation that the event or communication is a non-payment event or communication and/or an indication as to the nature of access application 1516. In various embodiments, the server management application 1532 of the server 120 may be configured to identify, based on the nature of the access application (e.g. described as part of the inputs to the transaction, event or communication as a gaming application, entertainment application, transportation application, etc.), by retrieving a designation from memory 1520, e.g. in account data 1524, that the access application 1516 does not have payment features and/or that the payment protocol used to verify a contactless card 101 and/or the user associated therewith and in relation to the access application 1516 does not employ the payment protocol to complete a payment. In various embodiments, the same protocol may be used to make a payment with respect to access application 1516, except an additional condition is imposed to make a payment, e.g. a first-level comparison of user credentials to stored information is made by the management application 1532 to enable solely non-payment activity, and a second-level comparison of user credentials to stored information is made to enable payment activity with respect to the access application 1516, where the first-level and second level comparison are initiated, respectively, by a first tap and a subsequent second tap of the contactless card 101 on the mobile device 1510.

In various embodiments, once the server 120 receives the communication or transaction data, it may transmit a response (e.g. from the issuer, e.g. authentication server of the issuer,) to a suitable component of the mobile device 1510, e.g. authentication service 1514, verifying the contactless card 101 and/or the identity of the user associated therewith based on the received cryptogram and the authentication service 1514 may grant access to a relevant portion or feature of access application 1516 as a result. The accesses feature may be the first-level and/or second-level information discussed above, e.g. in embodiments where no user credential comparison takes place, and/or any other suitable feature. In various embodiments, the verification is conducted and based one on or more cryptographic techniques discussed herein, including based on recreating the symmetric key and/or the entire cryptogram (the generation of which is based in party on using the symmetric key) by the issuer, e.g. authentication server of the issuer, in response to receiving the communication or transaction data. Since, in various embodiments, the operations as described in relation to the server 120 are associated with a payment protocol, including for application distinct from access application 1516, the cryptogram and cryptographic technique and the transmitted response are based on a payment protocol, but since at least one feature associated with access application 1516 is associated with a non-payment feature, and the payment protocol is performed to access the feature, the contactless card verification, and by extension user identity verification or authentication of the user, is also distinct from the payment protocol and competition of the payment protocol.

In various embodiments, the server 120 may utilize the counter log 121 to perform an antifraud measure. In various embodiments, counter log 121 may include time stamps associated with the counter value associated with one or more non-payment events or communications. In various embodiments, the counter log 121 may include time stamps associated with the counter value associated with one or more payment events or communications. In various embodiments, the counter value of the ATC in relation to a particular event or communication, e.g. whether it is a payment event or communication or a non-payment event or communication, may also be logged. The management application 1532 may be configured to compare a general number of payment events or communications that take place in between non-payment events or communications. If the number of payment events or communication after a non-payment event or communication exceeds a certain threshold, the management application 1532 may deny the payment events or communications, even if otherwise the event or communication may be completed (e.g. since it is assumed that a user may use the payment protocol for non-payment and payment protocol, an unduly large number of payment events or communications after a non-payment events or communications may be considered fraudulent). In various embodiments, the opposite may be implemented, e.g. a large number of non-payment events or communications being performed after a payment event or communication in excess of a threshold may cause the management application 1532 to deny a certain non-payment event or communication when the verification or authentication takes place. In various embodiments, a threshold in relation to time between any event or communication, e.g. payment or non-payment, in terms of exceeding a minimum or maximum threshold may cause the management application 1532 to deny the authentication or verification operation. The counter log 121 may be used to perform any other suitable operation, including perform an anti-fraud measure in any other suitable manner.

In various embodiments, the processor 1518 communicates the comparison result to the authentication service 1514 (e.g., for a match). In various embodiments, a first match may grant the user access to first-level aspects, e.g. user account options of a user account, associated with authentication application 1516 (e.g., display of an account balance and/or recent events or communications). Responsive to finding a first match, the authentication service 1514 initiates verifying or authenticating a user identity with one or more additional verification operations. For example, the authentication service 1514 may output for display on the mobile device 1510 a notification to bring a contactless card 101 near the mobile device 1510. The authentication service 1514 may then communicate with the contactless card 101 (e.g., after being brought near the contactless card 101). Communication between the authentication service 1514 and the contactless card 101 may involve the contactless card 101 being sufficiently close to the card reader 1534 of the mobile device 1510 to enable NFC data transfer between the authentication service 1514 and the contactless card 101. In various embodiments, the contactless card 101 sends, to the authentication service 1514, or another suitable component or application of the mobile device 1510, a public key of a public/private key pair and cardholder identification information of an account holder of the card, e.g. the contactless card and/or user to be verified or authenticated in relation to access application 1516. In various embodiments, the authentication service 1514, may instruct the contactless card 101 to generate a digital signature using a private key of the key pair of the card. In various embodiments, the cardholder identification information may be incorporated within the digital signature or otherwise conveyed with the digital signature.

In various embodiments, the contactless card 101 sends the digital signature to the authentication service 1514 or another suitable component or application of the mobile device 1510. In various embodiments, the authentication service 1514 may communicate the digital signature with the processor 1518, where the processor 1518 may verify the digital signature using the public key. For example, the contactless card 101 may provide a hash of the card's public key encrypted by a trusted source (e.g., a private key of a card provider), and verifying the digital signature may include: decrypting the encrypted hash (e.g., with a public key of the card provider); calculating a new hash of the digital signature; and comparing the decrypted original hash to the new hash for a match, at which point the card provider (e.g., issuer, e.g. authentication server of the issuer,) , and the transaction card may be authenticated.

In various embodiments, either the mobile device 1510 and/or the contactless card 101 may be configured to perform an antifraud measure utilizing a counter log 121 (not expressly shown with respect to the mobile device 1510).

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

What is claimed is:

1. A method of card-based authentication, the method comprising:
receiving, by a server, a request with a no payment transaction associated with a contactless card, the request indicating a request type and a card number, wherein the card number is communicated from the contactless card to a device when the contactless card is within a communication range of the device;
determining, by one or more computer processors, that the request type specifies to authenticate a user of the device; and
retrieving an indicator characterizing an identity of the user, wherein the indicator is retrieved based on identifying a match for the card number in a data source, wherein the indicator is associated with the card number in the data source, wherein the user is authenticated based on the indicator to obtain an authentication result.

2. The method of claim 1, wherein the server is configured to:
upon determining that the request type specifies to process a payment transaction for the user, perform a predefined operation to handle the payment transaction, wherein no indicator of the identity of the user is returned responsive to the request.

3. The method of claim 2, wherein the predefined operation comprises processing the payment transaction or forwarding the payment transaction for processing.

4. The method of claim 1, wherein the server is of at least one of a payment processor system, an acquiring entity system, a card network system, or an issuing bank system, and wherein the method further comprises:
returning at least one of the indicator or the authentication result to the application.

5. The method of claim 1, wherein the request type is indicated via a flag, and wherein the request further indicates a zero-amount authorization of payment.

6. The method of claim 1, wherein authenticating the user based on the indicator validates the contactless card as being a possession factor in a multi-factor authentication process that includes a knowledge factor or an inheritance factor.

7. The method of claim 1, wherein the device comprises a first device, wherein the request further indicates a device identifier of the device, and wherein the method further comprises:
determining that a binding exists between the device and the contactless card, based on identifying an association between the card number and the device identifier in the data source, wherein the indicator is only returned to the application upon determining that the contactless card is not only bound to one or more devices other than the device.

8. A non-transitory computer-readable medium containing a program of a server, the program executable to perform an operation for card-based authentication, the operation comprising:
receiving a request associated with a contactless card, the request indicating a request type and a card number, wherein the card number is read from the contactless card when the contactless card is within a communication range of a device, wherein the card number is read by an application configured to execute on the device;
determining, by one or more computer processors when executing the program, that the request type specifies to authenticate a user of the device; and
retrieving an indicator characterizing an identity of the user, wherein the indicator is retrieved based on identifying a match for the card number in a data source, wherein the indicator is associated with the card number in the data source, wherein the user is authenticated based on the indicator to obtain an authentication result, and wherein no payment transaction for the user is processed responsive to the request.

9. The non-transitory computer-readable medium of claim 8, wherein the program is further executable to:
upon determining that the request type specifies to process a payment transaction for the user, perform a predefined operation to handle the payment transaction, wherein no indicator of the identity of the user is returned responsive to the request.

10. The non-transitory computer-readable medium of claim 9, wherein the predefined operation comprises processing the payment transaction or forwarding the payment transaction for processing.

11. The non-transitory computer-readable medium of claim 8, wherein the server is of at least one of a payment processor system, an acquiring entity system, a card network system, or an issuing bank system, and wherein the operation further comprises:
returning at least one of the indicator or the authentication result to the application.

12. The non-transitory computer-readable medium of claim 8, wherein the request type is indicated via a flag, and wherein the request further indicates a zero-amount authorization of payment.

13. The non-transitory computer-readable medium of claim 8, wherein authenticating the user based on the indicator validates the contactless card as being a possession factor in a multi-factor authentication process that includes a knowledge factor or an inheritance factor.

14. A system of card-based authentication, the system comprising:
one or more computer processors; and
a memory containing a program executable by the one or more computer processors to perform an operation comprising:
receiving data from a contactless card, the data comprising a personal account number (PAN) associated with the contactless card and a user;
generating a test transaction to authenticate the user, the test transaction comprising the PAN and indicator indicating a request type of authentication of the user;
communicating the test transaction to one or more of a payment processor system, an acquiring entity system, a card network system, or an issuing bank system to perform an authentication of the user based on the test transaction comprising the indicator; and
receiving a result of the authentication from one of the payment processor system, the acquiring entity system, the card network system, or the issuing bank system.

15. The system of claim 14, wherein the system is configured to:
upon determining that another request type specifies to process a payment transaction for the user, perform a predefined operation to handle the payment transaction, wherein no indicator of the identity of the user is returned responsive to the request.

16. The system of claim 15, wherein the predefined operation comprises processing the payment transaction or forwarding the payment transaction for processing.

17. The system of claim 14, wherein the system is configured to:
returning at least one of the indicator or the authentication result to the application.

18. The system of claim 14, wherein the request type is indicated via a flag, and wherein the test transaction further indicates a zero-amount authorization of payment.

19. The system of claim 14, wherein authenticating the user based on the indicator validates the contactless card as being a possession factor in a multi-factor authentication process that includes a knowledge factor or an inheritance factor.

20. The system of claim 14, wherein the device comprises a first device, wherein the request further indicates a device identifier of the device, and wherein the operation further comprises:
determining that a binding exists between the device and the contactless card, based on identifying an association between the card number and the device identifier in the data source, wherein the indicator is only returned to the application upon determining that the contactless card is not only bound to one or more devices other than the device.
